(19) United States
(12) Patent Application Publication
(10) Pub. No.: US 2013/0133026 A1
(43) Pub. Date: May 23, 2013

(54) SYSTEM, METHOD, AND APPARATUS FOR DATA, DATA STRUCTURE, OR ENCRYPTION COGNITION INCORPORATING AUTONOMOUS SECURITY PROTECTION

(71) Applicant: Shelia Jean Burgess, Haymarket, VA (US)

(72) Inventor: Shelia Jean Burgess, Haymarket, VA (US)

(21) Appl. No.: 13/714,393

(22) Filed: Dec. 13, 2012

Related U.S. Application Data
(63) Continuation-in-part of application No. 12/164,844, filed on Jun. 30, 2008.
Application No. 12/164,844 is a continuation-in-part of application No. 11/968,509, filed on Jan. 2, 2008, now abandoned.
Application No. 11/968,509 is a continuation-in-part of application No. 11/281,198, filed on Nov. 16, 2005, now abandoned.
Application No. 11/281,198 is a continuation-in-part of application No. 13/324,778, filed on Dec. 13, 2011.
(60) Provisional application No. 61/570,162, filed on Dec. 13, 2011.

(51) Int. Cl. G06F 21/62

(52) U.S. Cl. CPC G06F 21/62
USPC 726/1; 726/28

(57) ABSTRACT

Aspects of the inventive subject matter relate in general to systems, methods, and apparatus for data cognition that incorporates autonomous security protection and embedded intelligence. More particularly, the inventive subject matter relates to systems, methods, and apparatus utilizing cognitive data, cognitive encryption key(s), and cognitive data structures or protocols that can perform analyses and assessments, self-manage and/or self-organize, secure its environment, evaluate behavior, detect security problems, adapt, work in conjunction with network communication and protocols, alert the data creator of an urgent situation (Situation Awareness), and provide traceability, electronic forensics, and possess self-knowledge so it can be discovered, searched, and support data management, dynamic endpoint security, and be influenced by user behavior.

### CROSS-REFERENCE TO RELATED APPLICATIONS

This application claims priority to U.S. Provisional Patent Application No. 61/570,162, filed Dec. 13, 2011. This application is a continuation-in-part of U.S. patent application Ser. No. 13/324,778, filed Dec. 13, 2011. This application is further a continuation-in-part of U.S. patent application Ser. No. 12/164,844, filed Jun. 30, 2008, which is a continuation-in part of U.S. patent application Ser. No. 11/968,509, filed Jan. 2, 2008, which is a continuation-in-part of U.S. patent application Ser. No. 11/281,198 filed Nov. 16, 2005, which is now abandoned. The disclosure of each of the applications referenced above is hereby incorporated by reference in its entirety.

### COPYRIGHT NOTICE

This patent document contains information and material subject to copyright protection. The copyright owner has no objection to the facsimile reproduction by anyone of the patent document or the patent disclosure, as it appears in the U.S. Patent and Trademark Office files or records, but otherwise reserves all copyright rights whatsoever.

### FIELD OF THE INVENTION

Aspects of the inventive subject matter relate in general to systems, methods, and apparatus for data cognition that incorporates autonomous security protection and embedded intelligence. More particularly, the inventive subject matter relates to systems, methods, and apparatus utilizing cognitive data, cognitive encryption key(s), and cognitive data structures or protocols that can perform analyses and assessments, self-manage and/or self-organize, secure its environment, evaluate behavior, detect security problems, adapt, work in conjunction with network communication and protocols, alert the data creator of an urgent situation (Situation Awareness), and provide traceability, electronic forensics, and possess self-knowledge so it can be discovered, searched, and support data management, dynamic endpoint security, and be influenced by user behavior.

Autonomous embedded data cognition enables data, cryptographic data, authentication codes, and the like to perform real-time environmental configuration control, self-manage, perform analyses, determine its current situation, and evaluate behavior to respond accordingly. When created, security measures, and access controls are selected. Highly sensitive data can be extracted and substituted with creator label and/or functional representation or tags that can be used to search for and discover said data. Data-to-data reasoning and analysis can be performed. Data can self-organize. The processing method comprises autonomous monitoring for a state change and analyzing the current user to determine if the instantiation should exist. If affirmed, the cognition engine automatically configures the computational environment in which it resides, resulting in dynamic endpoint hardening. If denied, environmental behavior is further analyzed for security problems or an erroneous situation. If detected, the creator is alerted and provided with incident information enabling remote creator control of the data. Cognitive data can decide to self-destruct mitigating risk of undesirable instantiations. Additional intelligence can be embedded in the data structure. Intelligent Agents, a comprehensive data structure, and intelligent document means are leveraged for implementation. Creation of an encryption key that leverages cognitive data capabilities of the inventive subject matter, as well as encryption key processing and management, optionally is implemented. Data cognition optionally comprises capabilities to permit it to process independent of a user interaction, as well as possess anti-tampering, anti-reverse engineering, and anti-debugging capabilities. The data structure can be applied to data files, non-real-time data, near-real-time data, and real-time data applications.

### BACKGROUND OF THE INVENTION

Society is bombarded with malicious cybercrime. Personal and corporate data theft, as well as data alteration, plague our reliance on computer technology. The US Security and Intelligent Documents Business Unit reported an estimated 13.3 people become victims of document and identity fraud every 60 seconds, with almost seven million victims per year. Botnets and hackers compromise networks to steal data. Cybercrime is rampant yet difficult to track. For example, a computer criminal can use open cyber cafe computers, moving from server to server, changing internet providers, use false information to register, and can steal service from unsecured wireless access points, in order to disguise identity and activities.

Once networks are penetrated, security means to protect data such as encryption, security protocols, data access, and authentication schemes are bypassed and are insufficient to maintain data security. It is widely accepted that disk encryption protects sensitive data when misappropriated. However, researchers at Princeton University demonstrated that even when encrypted, the data can easily be read without physical access to the computer. One way for a perpetrator to gain access to encrypted data is to also gain access to the encryption key and to apply the key to the data resulting in an unencrypted format. It is known to those skilled in the art of cryptography that the inability to completely protect the encryption key is a significant “weakness” of encryption.

Combating cybercrime and cyber terrorism is of daunting concern among federal officials who ask “when our networks are attacked and rendered useless, how do we regain access to our data?” The Pentagon alone logged 1,300 successful intrusions in 2005. Chinese hackers penetrated US State Department computers, of which hundreds had to be replaced or taken offline for months.

Company computer systems are protected by multiple layers of security including data encryption, Digital Rights Management (DRM), and Enterprise Rights Management (ERM). These server-centric solutions require access management infrastructure such as enterprise or licensing server communication to authorize data access. However, employee misconduct and unintentional actions like errors and omissions are the greatest cause of data security breaches in such systems. Criminal activity can and does occur inside corporations and agencies, where the perpetrator (e.g., an employee) has ready access beyond the security measures in place. Recent high-profile laptop thefts by insiders include a Veterans Administration computer containing information on 26 million veterans, and a University of California-Berkeley laptop with more than 98,000 graduate students' data.

In addition, emergency incidences that require first responders and other government agencies to resolve an incident at the national level as defined in the US Department of Homeland Security Nation Incident Management System (NIMS) may require classified data usage. Concerns in supporting NIMS include the loss of control of classified data instantiations that were shared during the incident.

Traditionally, intelligent documents are interactive electronic documents that usually require web or network server access. Network reliance makes these solutions vulnerable to security breaches. Even if the user is authorized to access the data, it is still not protected. Upon opening and disclosing the data or document contents, the computer environment in which it resides may not be secure. This scheme relies on network security and third party software such as virus protectors, spyware, and firewall protection. Hackers could breach the network, third party solutions may not detect the latest cyber threat or the user may not have the latest security update. Particularly for large businesses and government agencies for example, new threats to data files are constantly emerging as hackers become more bold, sophisticated, and focused. For example, advanced persistent threats (APTs) refers to the condition in which a group, such as a business competitor or foreign government, displays both the capability and the intent to persistently and effectively target a specific entity. An individual, such as an individual hacker, is occasionally but not usually referred to as an APT because such actors rarely have the resources to be both advanced and persistent, even if they are intent on gaining access to, or attacking, a specific target.

APTs are usually defined by the following characteristics: advanced threats often display a spectrum of intelligence-gathering techniques, which may include computer intrusion technologies and techniques. While individual components of the attack may not be classed as particularly “advanced”, APT operators often combine multiple targeting methods, tools, and techniques in order to reach and compromise their target and maintain access to it. Persistent threats often display focus on a specific task, rather than opportunistically seeking information for financial or other gain. This distinction implies that APT attackers are guided by external entities. Such targeting is conducted through continuous monitoring and interaction in order to achieve the defined objectives. One of the operator's goals is to maintain long-term access to the target, in contrast to threats who only need access to execute a specific task. APT attacks are usually executed by coordinated human actions, rather than by mindless and automated pieces of code. The operators have a specific objective and are skilled, motivated, organized, and often well funded.

Another avenue to unintended access to data is through the use of, and failure to protect against, hijacking of program debugging functions, reverse-engineering, and program tampering. Program debugging functions can be accessed and used as a “back door” for the unintended use of defeating program security. Similarly, programs can be reverse-engineered or otherwise tampered with, and their security protocols breached. Thus, whenever there is a separation of a program and the data that is operated upon by the program, there is an opportunity for a hacker to modify or circumvent security by attacking the external program itself. Obviously, once the external program is compromised, any data file that is intended to be protected is also compromised.

Additionally, economic and efficiency factors are driving users to find a solution for securing their data in a Cloud or virtual environment. Securing documents in a Cloud environment also requires securing the said data encryption and decryption keys. If someone gains access to these keys, they also gain access to the secured data. Also, if processes malfunction in the Cloud which is a multi-tenant environment, data, encryption keys, and other content that the owner may desire to protect may go to the wrong user or tenant leading to a compromised situation for the owner.

Data threats also abound in our Smart Grid, Microgrids, and the Global Grid, Weapon Platforms such as the unmanned aerial vehicles and any component or platform that shares and transmits data. These also include health care and financial systems that share data. Our critical infrastructure's Smart Grid SCADA (Supervisory Control and Data Acquisition) industrial control systems are known to be hacked. Some of the worst malware on the planet target these systems such as Stuxnet, Flame, and Duqu. Attacks on systems that can threaten our way of life must protect their data including their data structures. A data structure is a specific or particular way of organizing data which may include a specified data protocol to support non-real-time, near-real-time, and real-time applications/operations.

It is very desirable to provide users with the capability of limiting their exposure to cybercrime, data breaches, and protect data and data files to the point where even if the perpetrator is successful in overcoming network security barriers and obtains an instantiation of the data, it will be of no avail. Instead of relying on outside resources in application server-centric architectures, the data itself needs to be intelligent and autonomous. The data itself needs to evaluate its situation and employ cognition to advance to new degree of security and capabilities. Data needs to evaluate and configure its environment before it opens, analyze behavior, perform data-to-data relationship analysis, and take necessary measures for self-protection, self-destruction, and in certain circumstances, report back to its legitimate data creator who originated or has legitimate ownership of the data. If the data itself “knows” what it is, where it is, and how it should interact, it can configure and monitor the computer environment to support its own needs. In addition, data needs to further protect itself from Advanced Persistent Threats (APTs). There exists a strong need for data that possesses cognition and this level of security. Data that can “think for itself” and reason based on its situation could greatly advance data security and become a major roadblock for cybercrime and cyber terrorism.

In addition, it is very desirable to alternatively leverage the cognitive capabilities for the encryption/decryption keys, digital signatures, certificates, and message authentication codes. By way of example, it would be very beneficial for a data decryption key to “know” if it belongs in a particular user's environment and if not self-destruct in order to protect the key thus securing data that it can decrypt into plaintext. This self-defense capability is of particular importance in some situations due to the fact that Cloud data or multi-tenant storage increases the attack surface area. This inhibits Cloud providers and outside threats from gaining access to protected data as it further hardens the solution against attack vectors and possible virtual desktop infrastructure (VDI) challenges significantly reducing the attack landscape. This capability can be used with normal or typical encryption of data files and/or with cognitive data files. Alternatively, it is very desirable to leverage the power of the cognitive capabilities of the disclosed invention and apply the data structure to non-real-time, near-real-time, and real-time applications as in use as a protocol for example.

### SUMMARY OF THE INVENTION

The present inventive subject matter relates to a cognitive data system for autonomous data decision processing, comprising the following elements operably coupled:

a) a data file stored on a storage medium or memory device, and having stored instructions for an embedded autonomous executable program which is executed each time there is an attempt to access, control, or manipulate said data file;

b) a processor for executing said program;

c) an output device for communicating to a user, wherein said communication is based on the result of executing said program in relation to parameters required for said data file by a data file original creator; and

d) an input device for receiving a communication from said user.

The inventive subject matter further relates to an apparatus for handling a cognitive data file with autonomous data decision processing, comprising a non-transitory computer readable medium having stored instructions for an embedded autonomous executable program which is executed each time there is an attempt to access, control, or manipulate said data file, wherein said program instructions when executed comprise the following steps:

a) querying a user of said apparatus and a user environment comprising said apparatus for information required by the original creator of said cognitive data file;

b) receiving and analyzing said information in relation to security parameters required by said original creator;

c) determining the computational environment of said user and analyzing said computational environment in relation to environmental parameters required by said original creator; and

d) permitting or denying said user's access to said data file based on said analysis of the user and computational environment.

The inventive subject matter also relates to a method for securing a cognitive data file stored in a storage medium or memory device, said data file having stored instructions for an embedded autonomous executable program which is executed each time there is an attempt to access, control, or manipulate said data file, comprising the following steps:

a) querying a user of said data file and the user environment of said data file for information required by the original creator of said cognitive data file;

b) receiving and analyzing said information in relation to security parameters required by said original creator;

c) determining the computational environment of said user and analyzing said computational environment in relation to environmental parameters required by said original creator; and

d) permitting or denying said user's access to said data file based on said analysis of the user and computational environment.

Accordingly, one aspect of the inventive subject matter is a system, method, and apparatus for cognitive data to make decisions autonomously by self-processing and not relying on external processes and/or resources, resulting in intelligent/rational data.

Additionally, another aspect of the inventive subject matter is a system, method, and apparatus for cognitive data to make higher-order decisions or conclusions.

Additionally, a further aspect of the inventive subject matter is a system, method, and apparatus for cognitive data to make decisions autonomously and not rely on network, internet, or server resources to analyze and control the environment in which it resides, whereby the data has the capacity to self-protect, self-manage, and if need be, alert the data creator and even self-destruct, a form of self-modification.

Another aspect of the inventive subject matter is autonomous data security, severing reliance on network-centric solutions, systems administration, network management, and the creator to ensure the environment is free from unsafe conditions before accessing the data. Embedding autonomous security into the data itself mitigates potential security incidences and human errors.

Another aspect of the inventive subject matter is a method, system, and apparatus for limiting the creator's exposure to undesired data breaches and malicious cyber activity that involves theft or unscrupulous means of obtaining data by implementing a new security means of data processing wherein autonomous security can be embedded in data comprising digital documents, digital databases, digital data files, digital media, electronic mail/email, digital content, and digital multimedia.

Another aspect of the inventive subject matter is a method, system, and apparatus wherein only instantiations of data that the creator is aware of exist. Therefore, the data creator retains control of their data.

Another aspect of the inventive subject matter is a method, system, and apparatus to secure electronic mail/email.

Another aspect of the inventive subject matter is removing direct access to highly sensitive data by substitution of meaningful label fields, thus stripping out or masking the highly sensitive data to further protect it from breaches and erroneous handling.

Another aspect of the inventive subject matter is a method, system, and apparatus for data-to-data interrelationship behavior wherein these data can analyze and reason by and/or among themselves, enabling self-organization, analyses, calculations, and evaluations, thus performing intelligent situational analyses, making conditional determinations and present higher-order data conclusions.

Another aspect of the inventive subject matter is a cognition engine to enable a foundation for data intelligence, adaptivity, and reasoning.

Another aspect of the inventive subject matter is to create a method, system, and apparatus to create, use, and secure encryption and decryption keys.

Another object of the inventive subject matter is to create a method, system, and apparatus that can provide dynamic white listing and dynamic black listing of applications, processes, procedures, and services permitted. The allowed or blocked applications, processes, procedures, and services which may be based upon user behavior.

Another object of the inventive subject matter is to create a method, system, and apparatus to create, use, and secure a non-real-time, near-real-time, and real-time data structure and/or protocol. This data structure can be transmitted between and among components or elements.

Another object of the inventive subject matter is to create a method, system, and apparatus that can secure data in the Smart Grid, Microgrid, Weapon Systems Platforms, financial systems, medical systems, critical infrastructure, mobile systems, etc.

Another object of the inventive subject matter is to create a cognitive wrapper data structure.

Another object of the inventive subject matter is to create a method, system, and apparatus that can be used for data discovery. Data discovery enables the user to find and/or search for the data.

Another object of the inventive subject matter is to create a method, system, and apparatus that can be used for data discovery, which leverages data memory which can be internal to the data structure or external and possess attributes such as short-term memory and/or long-term memory or additional types of memory.

Another object of the inventive subject matter is to create a method, system, and apparatus that can be used for automation of the data life or life-cycle.

Another object of the inventive subject matter is to create a method, system, and apparatus is the creation of data that can be obfuscated, or self-obfuscate, or “fight-back”.

Another object of the inventive subject matter is to create a method, system, and apparatus that secures data in a Cloud, multi-tenant, mobile, and/or Virtual Desktop Infrastructure (VDI) environment.

Another object of the inventive subject matter is to create a method, system, and apparatus that secures encryption/decryption keys, digital signatures, certificates, and message authentication codes. in a Cloud, multi-tenant, mobile, and/or Virtual Desktop Infrastructure (VDI) environment.

Another object of the inventive subject matter is to create a method, system, and apparatus that secures data structures in a Cloud, multi-tenant, mobile, and/or Virtual Desktop Infrastructure (VDI) environment such as a protocol structure type for example.

Another object of the inventive subject matter is to create a method, system, and apparatus is the creation of data that can be obfuscated, or self-obfuscate, or “fight-back”.

Another aspect of the inventive subject matter is a method, system, and apparatus wherein the creator is alerted to an urgent or emergency situation wherein their data is compromised and/or obtained maliciously. This alerting could resolve serious infractions, thus enabling the creator to respond immediately to protect, for example, their privacy against situations such as identity theft through the misappropriation of data.

Another aspect of the inventive subject matter is a method, system, and apparatus that can secure data for privacy and/or security purposes for the data creator, for security of the data, and for protection of the data.

Another aspect of the inventive subject matter is a method, system, and apparatus wherein data self-modifies autonomously such as self-destruct.

Another aspect of the inventive subject matter is a method, system, and apparatus that can create and use cognitive encryption keys.

Another aspect of the inventive subject matter is a method, system, and apparatus that can securely manage, process, and/or store encryption keys.

Another aspect of the inventive subject matter is a method, system, and apparatus that can withstand APTs.

Another aspect of the inventive subject matter is a method, system, and apparatus that can deter unintended access to data being protected by leveraging anti-debugging, reverse-engineering, and tamper-proofing capabilities.

Another aspect of the inventive subject matter is a method, system, and apparatus that enables the data to process and/or execute its capabilities by leveraging a hypervisor, also called virtual machine manager, or an equivalent means so the data can process and/or execute its capabilities independently (e.g., the data file does not require a selection of the user to execute or process its capabilities).

Another aspect of the inventive subject matter is a data structure that can work on and/or support network processes and that can implement network intelligence at the data level.

Another aspect of the inventive subject matter is a data protection solution that can be leveraged for a server, an enterprise, cloud, and/or remote management, control, and storage.

One more aspect of the invention is a method, system, and apparatus in which data are self-managed and self-controlled, for example, depending on the level of security the data needs, behavior evaluations the data performs, time-of-day, frequency accessed, age, access duration, security and/or sensitivity level, and data field attributes of the particular data created according to the creator preferences.

In summary, the disclosed methods, systems, and apparatus satisfy all of the needs described and advantageously protect user's exposure to undesired and malicious activity by employing advanced control mechanisms implemented, in one embodiment, as an embedded data processing capability. The inventive cognitive data methods, systems, and apparatus permit the creator and/or the originating party(ies) that have legitimate ownership to said data, to proactively take control of whom, how, when, and if another party may possess their data. Advantageously, the disclosed methodology transforms data from a passive file that can be obtained, compromised, and misused by anyone, to a cognitive data instantiation that possesses environmental control and self-management characteristics, offering the creator protection, security, and advanced analyses. The transformed data optionally possesses the abilities to self-execute and deter tampering, reverse engineering, and debugging.

Upon the creator associating key words, key aspects, and/or key data body elements with labels and/or functions, these can be leveraged for analyses and to discover or find the data as in a data search. This capability can further customize cognitive data per the creator's priorities and needs, in order to keep sensitive data private. It also provides an intelligent means for unique configuration of the environment based on data security requirements, in order to self-protect while in use. Cognitive data are managed and controlled depending on the environment, state, security, trust, and the intelligence level of the particular cognitive data instantiation. The data can perform behavior analyses to support its needs and those of its creator or user. The creator is empowered to take control over and limit access to their private sensitive data. Artificial Intelligence is also implemented to create an adaptive data cognition capability.

Further, a method, system, and apparatus is disclosed for the creation and processing of cognitive data, which may result in a cognitive data file type, cognitive encryption key type, and/or cognitive data structure of a protocol type where a protocol is a well-defined digital message or format of data that can be transmitted between computational components. Encryption keys are defined as a piece of information such as a parameter that determines the functional output of a cryptographic algorithm or cipher which refers to encryption, decryption, digital signatures schemes, certificates, and message authentication codes. In particular, the system or apparatus is a framework that comprises a cognition engine, cognitive data structure, and supportive processes in a computational environment such as a computer. The computer may reside in a network, an enterprise, be stand-alone, or in a Cloud environment. Creator preferences upon creation of cognitive data are selected from a plurality of cognition and security levels, access and data management controls and policies, and permissions upon creation of cognitive data. A data stripper or masker optionally is used to extract and encrypt highly sensitive data, which may be represented, for example, with associated data field labels and/or data tags. The associated data field labels, data memory, and other data features can optionally be leveraged to perform data-to-data evaluation, data discovery or a search for data, and behavior analyses.

The corresponding method comprises steps monitoring the computational environment for a change of state in an instantiation of cognitive data, determining who originally created the data, who owns the data, if the current user is the data creator, and if the user and/or computational environment is permitted to possess the cognitive data instantiation. If the instantiation is permitted, the security requirements are determined. Then, the environment is configured accordingly, finally granting the current user access to the data dependent on the creator controls and limitations. If the instantiation is not permitted, the cognitive data performs self-analysis and self-management which comprises the data's level of insecurity, behavior analysis, data-to-data analysis, and modification such as self-destruction analysis, self-obfuscation, or some other self-modification. The computational environment user's behavior is monitored. When the cognitive data detects misappropriation, it optionally alerts the creator, the alert comprising the identity of the perpetrator and the perpetrator's computing environment, enabling creator remote control of the cognitive data even after a breach situation. This method optionally incorporates anti-tampering, anti-reverse engineering, and anti-debugging into the autonomous cognitive data instantiation. An autonomous cognitive data instantiation can perform functions remotely such as self-destruction and sending attribution information back to the creator about its remote environment. This enables the creator to perform traceability and electronic forensics (e-forensics) analyses based upon the data collected from the autonomous cognitive data, all to deter threats that seek unintended access to the data contents.

Additionally, the corresponding method optionally comprises a step of leveraging a hypervisor that monitors the computational environment for an event, a time, or some other variable in the environment that triggers the cognitive data to execute accordingly.

### BRIEF DESCRIPTION OF THE DRAWINGS

The features of the invention believed to be novel are specifically set forth in the appended claims. However, the invention itself, both as to its structure and method of operation, may best be understood by referring to the following description and accompanying drawings.

FIG. 1 is a functional block diagram showing the overall relationship of an exemplary cognitive data system, method, and apparatus relative to environments in which it resides.

FIG. 2 is a functional block diagram showing the basic elements of an exemplary cognitive data framework according to one aspect of the inventive subject matter.

FIG. 3 is a flow diagram of an exemplary Cognitive Data Processor security level process according to one aspect of the inventive subject matter.

FIG. 4 is a flow diagram of an exemplary Cognitive Data Processor intelligence level process according to one aspect of the inventive subject matter.

FIG. 5 is the flow diagram of an exemplary Cognitive Data Processor data access process according to one aspect of the inventive subject matter.

FIGS. 6 and 7 are the flow diagrams for an exemplary data structure process according to one aspect of the inventive subject matter.

FIG. 8 is the flow diagram of an exemplary data stripper process according to one aspect of the inventive subject matter.

FIG. 9 is the environment process flow diagram of an exemplary current cognitive data instantiation according to one aspect of the inventive subject matter.

FIG. 10 depicts an exemplary Intelligent Agent functional block diagram showing the overall components of a simple Intelligent Agent structure according to one aspect of the inventive subject matter.

FIG. 11 is a block diagram of an exemplary cognitive data Multi-Agent System depicting the components and their relationships according to one aspect of the inventive subject matter.

FIG. 12 is the flow diagram of an exemplary Watcher Intelligent Agent according to one aspect of the inventive subject matter.

FIG. 13 is the flow diagram of an exemplary Approver Intelligent Agent for the Watcher Agent precept according to one aspect of the inventive subject matter.

FIG. 14 is the flow diagram of an exemplary Creator Approver Intelligent Agent for the Snitcher Agent precept according to one aspect of the inventive subject matter.

FIG. 15 is the flow diagram for an exemplary Snitcher Intelligent Agent of the Approver precept according to one aspect of the inventive subject matter.

FIG. 16 is the flow diagram for an exemplary Snitcher Intelligent Agent of the Health precept according to one aspect of the inventive subject matter.

FIG. 17 is the flow diagram for an exemplary Health Intelligent Agent of the Snitcher Agent, Approver Agent, and Tracker Agent precepts according to one aspect of the inventive subject matter.

FIG. 18 is the flow diagram for an exemplary Tracker Intelligent Agent of the Watcher precept according to one aspect of the inventive subject matter.

FIG. 19 is the flow diagram for an exemplary Behavior Intelligent Agent flow diagram for the enterprise location according to one aspect of the inventive subject matter.

FIG. 20 is the graphical representation of an exemplary Work Schedule membership functions according to one aspect of the inventive subject matter.

FIG. 21 is the graphical representation of an exemplary Remote Environment membership functions according to one aspect of the inventive subject matter.

FIG. 22 is the graphical representation of an exemplary History Usage membership functions according to one aspect of the inventive subject matter.

FIG. 23 is the flow diagram for an exemplary Fuzzy Inference processing according to one aspect of the inventive subject matter.

FIG. 24 is a block diagram of exemplary hardware resources needed to support the cognitive data system, method, and apparatus disclosed, wherein the implementation of the hardware can either be as a standalone unit that interfaces to external device functions or an integrated element/feature set according to one aspect of the inventive subject matter.

FIG. 25 is a representation of an exemplary cognitive data structure according to one aspect of the inventive subject matter.

### DETAILED DESCRIPTION OF THE INVENTION

The disclosed cognitive data systems, methods, and apparatus enable the creator of sensitive and private data to protect data and to maintain control of it even after an intrusive breach and/or malicious activity.

Control over and ownership of data files is expected in many instances to include not only the actual individual “creator” of a file, but also persons and/or entities associated with such an individual creator, such as an employer, supervisor, and/or authorized colleagues. The term “creator” or “data creator” are used interchangeably herein and collectively refer to all persons and/or entities associated with an individual creator and given the same rights as such individual. The inventive subject matter offers at a minimum data protection, privacy, security, and data cyber capabilities to the creator. Advantageously, the disclosed system, method, and apparatus enable users such as consumers to regain control and protection of their digital data while stored (at rest), in transit (in motion), or while they are using it (in use) by creating data that establishes privacy and autonomous data security at a whole new level by embedding these enabling capabilities. The protected data or data files may comprise digital data files types, encryption keys, and data structures such as a data protocol. These capabilities can also be leveraged, for example, to prevent or mitigate fraud in the Medicare system or in the financial industry.

Along with these advantages, the creator of the data can embed proactive preferences for data management, data actions/intelligence, obfuscation, discovery, life, data autonomous capabilities, and advanced capabilities such as being alerted to another party acquiring their data and the status of said data. The creator can optionally indicate if their protected data should self-manage such as self-obfuscate or self-destruct, thus eliminating the misappropriated data. Upon self-destruction, the memory in which the data was stored could also be overwritten to inhibit hackers from reading the memory where the data resided to obtain a copy of said data. Other autonomous functions can be added to the cognitive data. This capability enables the creator to have and maintain remote control of their data, and provides users with retroactive security upon the event of a data breach, attempted fraud, or cyber attack.

For purposes of illustration only, and not to limit generality, the cognitive data system, method, and apparatus will be explained with reference to its use in a digital computer environment, which may or may not exist in a networked environment, an enterprise or enclave environment, a wireless environment, a mobile environment, a Cloud environment, or the like. The terms “cognitive data” and “intelligent data” are equivalent and are used interchangeably herein. The term “data” may comprise or represent data itself, content, metrics, component settings, data fields, records, etc. “Data” is of course necessarily a term that refers to data which is stored, in transit, or in use in the form of a “data file”, and those terms are used interchangeably herein. The states, framework, creation, data and environment management, and processing of cognitive data comprises one example of this application. The cognitive data system, method, and apparatus comprises automated control logic that intelligently integrates data control and management functions, yielding a proactive system with embedded user control preferences and data cognition. This automated control logic can implement data security standards though the use of rule-based logic as an aid to automate a data security policy, such as the Health Insurance Portability and Accountability Act (HIPPA”) standards.

This cognitive data system, method, and apparatus relates to data which can be in one of at least three states:
Active or “Awake” state, wherein the data is being used, created, manipulated, opened, modified, copied, etc. [Data in Use]
Dormant or “Sleep” state, wherein the data is not in use (e.g., the data is stored on digital media). [Data at Rest]
Moving state, wherein transmission of the data is taking place. Moving state can be considered a type of “Awake” state, as the cognitive data is aware of this event. [Data in Motion]

While the various states may be dependent upon the user interaction with the data (i.e., the user selects the cognitive data file), the cognitive data system, method, and apparatus optionally also leverage a hypervisor or similar means that enables the cognitive data instantiation to execute independent of user interaction.

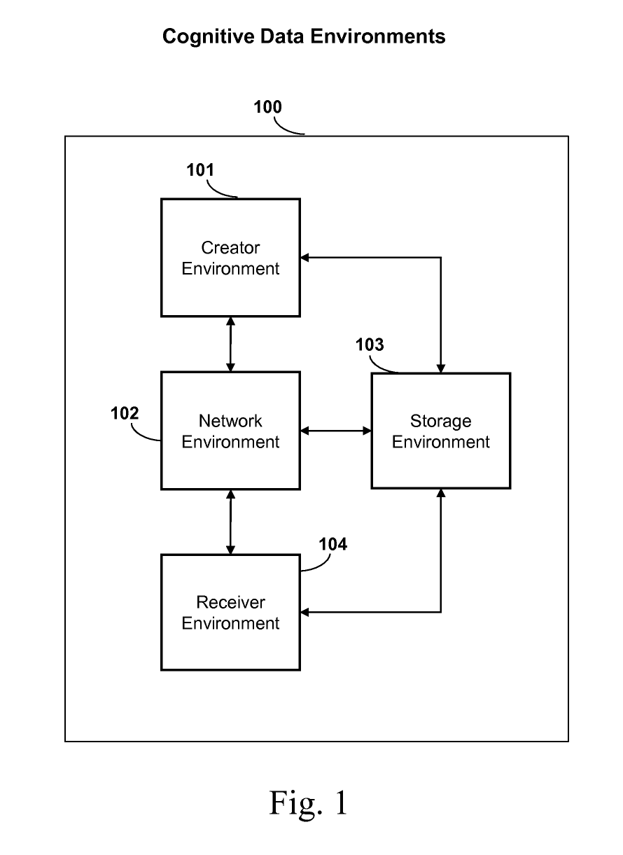

The cognitive data system, method, and apparatus can exist in a plurality environments or domains. More particularly, FIG. 1 is a functional block diagram showing one aspect of the inventive subject matter in which the overall relationship of an exemplary cognitive data system, method, and apparatus 100 relative to environments or domains in which the cognitive data can reside and function. Data can exist in a creator environment 101 which is the environment from which the data originated (i.e., original instantiation). Data may also reside in the network environment 102 (e.g., an internet, server, cloud, enterprise, and //or network equipment or device server) which may or may not be remotely located. Data can reside in a storage environment 103, some of which may or may not be remotely located (e.g., media storage resources, hard drives, DVDs, CD-ROMs, disk drives, media sticks, storage devices, memory devices, remote devices, etc.). This environment is operably connected and can be accessed either via the creator environment 101 directly (i.e., the media device port communication with the creator environment port via hardware or wirelessly) or indirectly via a network environment 102 (e.g., a local network server or residing remotely via internet resources). Finally, the data may reside in a receiving party's environment 104 such as a receiving party's digital computing device, which comprises any digital device that is used to process data, including but not limited to a computer, a mobile device, a server, a network device, a communications device, remote access devices, wifi devices, enterprise computing devices, cloud computing devices, etc. Data can be received and accessed in the receiver environment 104 via an operably-connected storage environment 103 resource or via a network environment 102 resource. Access to remotely stored data is accomplished via the network 102 via wired or wireless connection.

Remotely stored data can be managed and/or controlled by logging data instantiation flow, access, user permissions, and other pertinent data to track and determine access to said data. Said management and control logic optionally resides in a network environment 102.

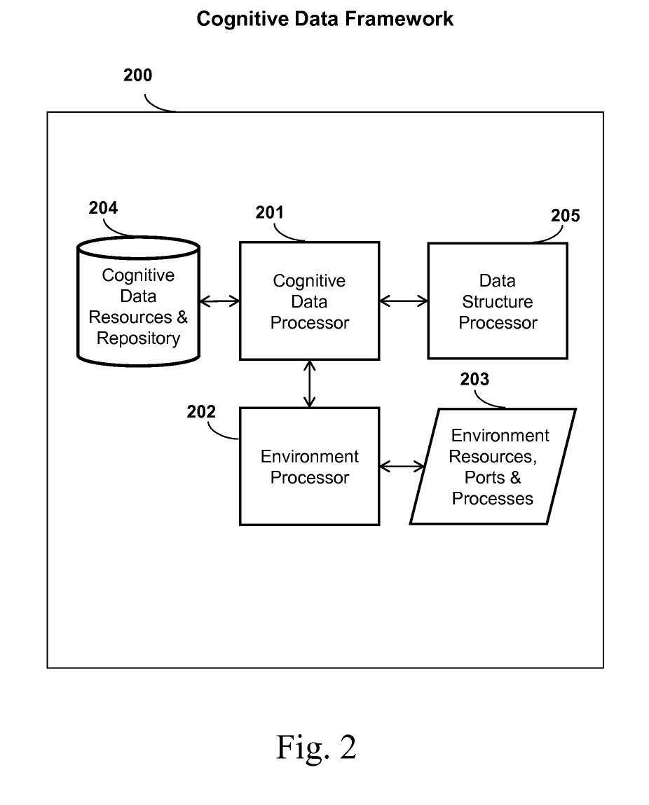

An exemplary cognitive data framework 200 is depicted in FIG. 2. This framework comprises an Cognitive Data Processor 201 which enables the overall cognitive data processing, creation, cognition, and control. The Cognitive Data Framework 200 also comprises an Environment Processor 202 to configure, secure and control environment resources upon a “state” change of the cognitive data. The Environment Processor 202 configures and controls ports, devices, resources, services, and processes 203. The Environment Processor 202 can leverage black listing and white listing which are commonly used to control which processes and services are permitted to function or blocked from executing. This can be performed on a continual basis or dynamically thus hardening the computational environment as needed. Creator preferences and resources needed to create, support, and process cognitive data are provided and stored in the environment's Cognitive Data Resources and Memory Repository 204. The Cognitive Data Processor 201 accesses the Data Structure Processor to create and access cognitive data 205. The cognitive data type being created can either be selected by the user or an external process in the system. For example, if a cognitive encryption key is desired from a cryptographic process in the system, it would request the Data Structure Processor 205 to create a cognitive encryption key data type.

For a functional processing example, suppose a user of an environment decides to access the internet while a high level of security cognitive data content is active or disclosed and decrypted; the Environment Processor 202 would close the high security cognitive data file then, open the port communication and activate the processes necessary 203 for the user to access the internet. Conversely, the port communication would be closed in order to re-open the cognitive data file. Additionally, the Cognitive Data Resources and Repository 204 may comprise log information, Intelligent Agents (IA) instantiations to be used and/or associated with cognitive data, stripped data (i.e., masked data elements or fields extracted or stripped out of the main body of a cognitive data file), additional metadata, or combinations thereof. Access to the Cognitive Data Resources and Repository 204 may be restricted to provide additional protection to secure the contents.

The Cognitive Data Processor 201 components in this embodiment comprise a Security Level Process, Intelligence Level Process, Access Process, Data Structure Process, Stripper Process, Environment Process, and a cognition engine produced by a Multi-Agent System (MAS). The cognition engine is incorporated into the cognitive data file/cognitive data structure. A comprehensive data structure is incorporated into this processing. This embodiment produces a cognitive data set, wherein a cognitive data file is produced along with an associated stripped or masked cognitive data file containing highly sensitive information to be protected. Stripping the highly sensitive information is an optional embellishment to further the security of specific data fields such as social security numbers.

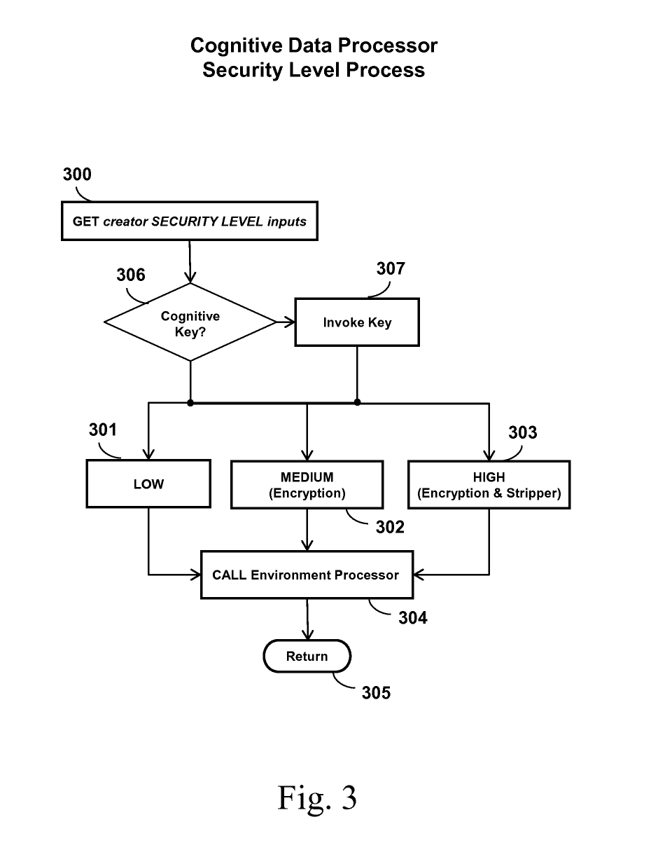

Further examination of the cognitive data as it relates to self-protection management requires security level knowledge. FIG. 3 depicts the Cognitive Data Processor 200 for security level processing flow. Optionally, a plurality of security levels can be implemented and supported. By way of example, this embodiment obtains a security level setting from the cognitive data creator via an input device such as a keyboard and/or mouse inputs at a digital computer, wherein the Cognitive Data Processor reads the desired user security level setting 300 from a plurality of settings comprising, in a simple example, low 301, medium 302, and high 303 security level selection possibilities. Then the Environment Processor is called as the security level selection influences the environment settings required to access and activate cognitive data. For example, the medium security level setting may require the environment close ports to the internet while the cognitive data is in the “active” state.

By way of example for this embodiment, the medium 302 security level will incorporate the environmental settings for the low security level plus encrypt the resulting data. Encryption can be achieved via standardized commercially available software and/or operating system calls. For example, Microsoft's Windows Operating System's Data Protection Application Programming Interface (DPAPI) consists of a pair of function calls that provide Operating System-level data protection through data encryption. Since the data protection is part of the Operating System, securing data can be achieved without the need for any specific cryptographic code other than the function calls to DPAPI. The Cryptprotect_Promptstruct is the “prompt structure” and the protected data structure holds the protected data. The two functions comprise the protect data function CryptProtectData and the complimentary unprotect function of CryptUnprotectData. Both of these functions use the syntax detailed below (i.e., CyrptProtectData would be swapped with CryptUnprotectData to decrypt the data):

```
BOOL WINAPI CryptProtectData(
  DATA_BLOB* pDataIn,
  LPCWSTR szDataDescr,
  DATA_BLOB* pOptionalEntropy,
  PVOID pvReserved,
  CRYPTPROTECT_PROMPTSTRUCT* pPromptStruct,
  DWORD dwFlags,
  DATA_BLOB* pDataOut
);
```

wherein parameters are defined as the following:
pDataIn:
   [in] Pointer to a DATA_BLOB structure containing the plaintext to be encrypted.
szDataDescr
   [in] String with a readable description of the data to be encrypted. This description string is included with the encrypted data.
pOptionalEntropy
   [in] Pointer to a binary large object (BLOB) containing a password or other additional entropy used to encrypt the data. The BLOB used in the encryption phase must also be used in the decryption phase. This parameter can be set to NULL for no additional entropy.
pvReserved
   [in] Reserved for future use and must be set to NULL.
pPromptStruct
   [in] Must be set to NULL because the CRYPTPROTECT_PROMPTSTRUCT structure is not used.
dwFlags
   [in] Bitmask of flags. The following table shows the flag values that are defined.

If encryption/decryption uses cognitive encryption keys 306, these keys are invoked 307. If not, processing continues as typical with the DPAPI. Using cognitive encryption keys will enable the solution to leverage the cognition capabilities that will be discussed later. In this particular example, the high 303 security level selection incorporates all the security means of the medium level of security as well as strips the data. Data stripping is discussed below. The security level selection is used as an input into the Environment Processor 304 which configures the environment to the appropriate level of protection. Once the Environment Processor is invoked and returns this process ends 305.

As will be reasonably apparent to one of skill in the art, more or less than three gradations of security level can be implemented while remaining within the scope of the inventive subject matter.

Upon encrypting data, encryption tools produce a key that is needed to decrypt the data that has been encrypted. This key varies in size. For example, the Advanced Encryption Standard (AES) currently produces key sizes of 128, 192, or 256 bits with block sizes of 128 bits; but the key size has no theoretical maximum. This key needs to be protected as anyone that possesses the key can apply it and successfully decrypt the data and gain access to the data content that is to be protected. Therefore, a key manager process and/or service can be implemented to scramble the encryption key using cryptography. By way of a very simplistic example to exemplify the process, assume an encryption key to be 8 bits. To scramble theses bits, they can be reversed and additional random bits can be added to the beginning, middle, and end as shown below:
Encryption key: A B C D 1 2 3 4
Scrambled key: XXXX 4 3 2 1 YYYY D C B A ZZZZ
   The scrambled key is now written to memory for secure storage. The scrambled key must be presented to the key manager process so it can decode the scrambled key to produce the original encryption key. Then, the key manager process can use the encryption key to decrypt the encrypted data. The intent of this step of processing is to add randomness to the encryption key logic resulting in a scrambled key and to provide logic that requires a system process to descramble the encryption key. Thus, the encryption key is not obvious nor directly accessible from storage.

Another approach to protecting the encryption key is to leverage the cognitive data subject matter disclosed herein. For example, this approach would convert the encryption key into a cognitive data file type, where the key is armed with embedded intelligence so it “knows” where it should be and how it should behave based upon where it is. If the key is not in an environment that is “acceptable”, the key itself optionally could self-destruct and/or send an alert to the owner of the key. If the key was in an acceptable environment, it could be applied to its associated encrypted data. In this example, the key itself is not encrypted as the process would become convoluted. However, a commonly known approach of hashing could be applied to further protect the key, in which the key itself could be hashed with some other known identifier such as an environment identifier (e.g., MAC ID, System ID, User ID, etc.). Leveraging this capability addresses a major weakness in encryption as it is used today.

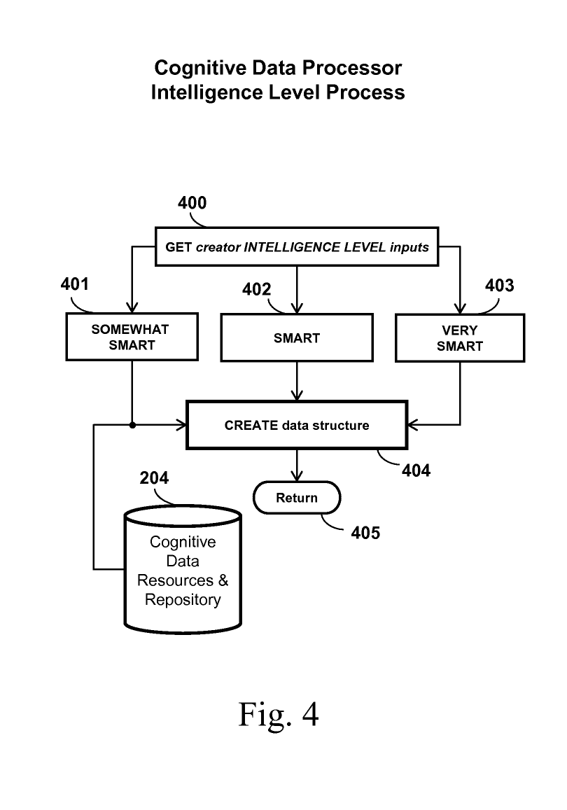

The Cognitive Data Processor 201 also provides a means for the creator to select “how smart” the cognitive data should be. “How smart” is likened to what functions the creator wants the data to perform and what the creator wants the cognitive data to do at a minimum. FIG. 4 depicts the Cognitive Data Processor 200 intelligence level processing flow. A plurality of intelligence levels can be implemented. By way of example, this embodiment obtains an intelligence level setting from the cognitive data creator via a keyboard and/or mouse inputs wherein the Cognitive Data Processor 201 reads the creator selected data intelligence level setting 400 that ranges from a basic level, “somewhat smart” 401, to an intermediate level, “smart” 402, and to a high level, “very smart” 403. For the “somewhat smart” 401 case, the cognitive data is created 404 leveraging resources from the Cognitive Data Resources and Repository 204. (The smart data structure is defined later.) If the “smart” 402 level of intelligence is selected, a more cognitive creation of the cognitive data structure is created. In one example of the process for raising the cognition level, additional data fields than those in the “somewhat smart” case are used. And finally, if the “very smart” 403 intelligence level is selected by the creator, the maximum intelligence that can be achieved is created for example, all the available smart data structure fields are included. Once the cognitive data structure is created 404, this process ends 405. Note that the cognition can comprise functions such as self-obfuscation if in an “untrusted” environment and/or if the user behavior is “untrusted”.

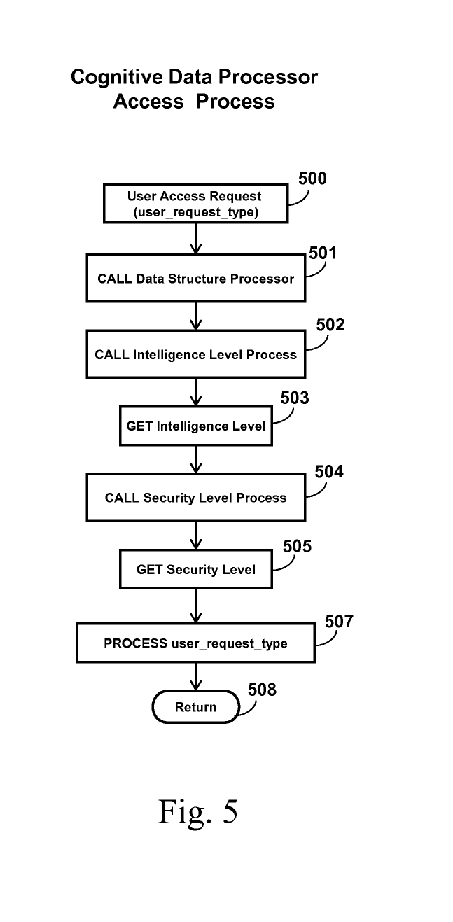

The Cognitive Data Processor 202 also uses an Access Process that provides “access to” and/or “creation of” cognitive data. FIG. 5 depicts a flow diagram of the Cognitive Data Processor 202 access process. This process commences upon being called from the Cognitive Data Processor 202 MAS (the MAS will be discussed later), requesting user access to the cognitive data and passing the “user_request_type” argument 500. The Data Structure Processor is called to create and/or access the cognitive data 501. The Intelligence Level Process is called 502 and the intelligence level field is read 503. Then the Security Level Process is called 504 to obtain the security level 505 required to access or create the cognitive data which subsequently calls the Environment Processor to configure the computer environment to meet the needs of the security level read from the data structure. Now Access Process is ready to execute the user_request_type 507 dependent on the prior processes controls, configuration, and parameters and returns to the calling process 508.

The Data Structure Processor 205 relies on the cognitive data file or record contents and structure. Primarily, the cognitive data file or cognitive data record or structure by way of example in this embodiment comprises the following fields, metadata, memory, tags, policies, and elements. Greater data cognition can be achieved upon leveraging the additional data fields for the “very smart” and “smart” cases beyond the “somewhat smart” data fields. Fields that are marked with “(vs)” are included in the “very smart” intelligence level data structure; fields marked with “(s)” are included in the “smart” intelligence level data structure; and fields marked with “(ss)” are included in the “somewhat smart” intelligence level data structure wherein a subset of these data fields comprises a less cognitive data structure:
1. Cognitive Data Structure Type
   File type
   Encryption key type
   Near-real-time type
   Real-time type
   Protocol type
2. Header/Identifier Information [(vs) (s) (ss) for all fields]
   Name
   Size
   Type
   Application(s) associated with the data
   Time stamp
   Date modified
3. Environment System Identity [(vs) (s) (ss) for all fields]
   A. (obtained from the ipconfig/all command)
      Host Name
      Domain name system (dns) server(s) addresses
      Primary DNS suffix
      Node type
      Internet protocol (IP) routing enabled
      Windows Internet Name Service (WINS) proxy enabled
      Physical address
      Dynamic Host Configuration Protocol (DHCP) enabled
      Auto configuration enabled
      IP address
      Subnet mask address
      Default gateway address
      Dhcp server address
      Connection specific dns suffix and description
   B. Additional [(vs) (s) fields]
      Use of digital certificate, license, and/or digital signature identifiers
      Use of registration data
      Use of claims or tokens (with .NET environments)
4. Creator Identity (in addition to using the environment identifiers)
   (first instance of cognitive data creation only)
      Name [(vs) (s) (ss)]
      License key if authentication is used [(vs) (s) (ss)]
      Registration/authentication data [(vs) (s) (ss)]
      Configuration data; a snapshot of the environment to use for comparison in future processing to aid further identification verification of the creator [(vs)]
5. User Identity [(vs) (s) (ss)]
   Name [(vs) (s) (ss)]
   License key if authentication is used [(vs) (s) (ss)]
   Registration/authentication data [(vs) (s) (ss)]
   Configuration data; a snapshot of the environment to use for comparison in future processing to aid further identification verification of the user [(vs)]
6. Security Level Setting
   High: Encrypt and Strip [(vs) (s) (ss)]
   Medium: Encrypt [(vs) (s) (ss)]
   Low:
      No internet access [(ss)] or,
      Limited internet access [(vs) and (s)] wherein trusted sites may be allowed
7. Classification Level if appropriate
   Confidential (yes/no) [(s)]
   Classified (yes/no) [(vs) (s)]
   Secret (yes/no) [(vs) (s)]
   Top Secret (yes/no) [(vs) (s)]
8. Current TRUST value (0, 5, 10) in this example [(vs) (s) (ss)]
9. Resource Restrictions or User Requests Allowable Settings (may also be dependent on Security Level Setting; the higher the security level, the greater the restrictions and/or user settings/preferences).
   Restrict Copy (yes/no) [(vs) (s)]
   Restrict Print (yes/no) [(vs) (s)]
   Restrict Edit (yes/no) [(vs) (s)]
   Restrict Delete (yes/no) [(vs) (s)]
   Restrict Save (yes/no) [(vs) (s)]
   Restrict View (yes/no) [(vs) (s)]
   Restrict Move (yes/no) [(vs) (s) (ss)]
   Restrict Analyze (yes/no) [(vs)]
10. Environment Control settings as a function of the Security Level
   Network status (e.g., using the operating system command “netstat-a” which returns information regarding anyone else being connected to your environment through any port as well as provide a list of all the open ports (a potential remote entry) wherein close port (port identity) for each port not needed this includes closing remote ports (remote port shutdown) [(vs) (s) (ss)]
   Close software application (application name) for each application not needed [(vs) (s) (ss)]
   Close resource device (resource identity) for each device not needed [(vs)]
   Allowable file manipulations dependent on security level [(vs) (s) (ss)]
      High Security: Authenticated printing, copying, screen prints, data modification
      Medium Security: Authenticated modification
11. Age control [(vs) (s) for all fields]
   Initial creation time and date
   Age limit or expiration (per timer setting or an expiration associated to an event or a date or duration)
   Update save times
   Duration while active
   Time of day access
   Day of week
12. Intelligence Level Setting (this field indicates appended support functions enabling intelligence) [(vs) (s) (ss) for all fields]
13. Stripper [(vs) (s) (ss) for all fields]
   Stripper identity
   Stripper attributes
   Stripper encoding
14. Associated Label [(vs) (s) (ss) for all fields]
   Stripper identity label
   Stripper attributes label
   Stripper encoding label
15. Related Data Names [(vs)]
   This field permits the user to associate other data with this one.
16. The Body [(vs) (s) (ss) for all fields]
   The actual content record being created (this may also be a database or tables, media, multi-media, etc.)
      (Encrypted if security level is greater than “low”)
17. The Data Memory [(vs) (s) (ss) for all fields]
   Short-term memory tags or fields
   Long-term memory tags or fields
18. Disclaimer [(vs) (s) (ss) for all fields]
   Statement regarding the data created has limited permission of its existence wherein its existence may be controlled by the creator.

As network capabilities and protocols continue to develop and expand their functionality, the cognitive data instantiation can be leveraged. For example, number 1 of the above list of data fields in the data structure comprises elements that may be associated to a protocol or other network intelligence capability. An example of how this may be used comprises a cognitive data which permits network resources to examine the network information fields to further determine the communications route to send the data. This route can then append the data packet with information that logs the route taken. By way of example, the cognitive data packets are sent to the network resources that are identified as associated to the data.

The cognition engine embedded in the cognitive data instantiation can also possess a process that is leveraged to support network capabilities. For example, a process may be embedded that leverages network identifier fields wherein the identifier needs to be an acceptable identifier to route the data. If the network data does not match the acceptable identifier, the data will self-destruct or perform some function that is acceptable to the data owner. Upon self-destruction, the data can also issue a function to overwrite the memory in which the data resided.

Network information can also include email/electronic mail data. By way of example, the email/electronic mail data could be a flag that can be set to permit said data to be emailed or the said flag can be set to deny the data from being successfully emailed. Therefore, in this example if the user attempts to send cognitive data wherein the flag is set to deny its emailing capability, the email attempt will fail and said cognitive data will never leave its environment. Policies can also support alerting of this situation in an enterprise environment.

The short-term and long-term memory tags may comprise key words that can be leveraged to support user discovery of the data existence as in a search for key words that exist in cognitive data files for instance.

Note that the “creator” is uniquely identified at the first instantiation of the cognitive data creation. All other instantiations check the identity of the “current user” to determine if the original creator is the current user. This distinction is necessary to afford the original creator control of their cognitive data even from a remote environment. It should also be noted that a log is created by an event tracker (i.e., the Tracker Agent which will be discussed later). This log data is comprised of all the data structure fields except the body. These fields are needed to provide traceability of the cognitive data. Audit logs, creator activity, and other analyses and can be generated/performed leveraging the Tracker logs.

The cognitive data file or cognitive data record set can be implemented as an “intelligent document”. “Intelligent document” is a general term to describe electronic documents with more functionality than a page designed to emulate paper. For example, the PDF from Adobe, InfoPath from Microsoft, Cardiff Software and XForms from W3C, and the non-programming solutions AjlDocs and Intelledox are intelligent documents and are based on using XML as a format for data. Intelligent documents are essentially interactive electronic documents. This capability is used to enable the cognitive data to respond to various state changes and events as well as interact with other processes disclosed herein.

To proceed, the “trust” parameter is introduced. “Trust” is a relative confidence parameter or measure where increased “trust” infers a qualifier of security. Conversely, the “trust” parameter can be decreased to infer risk. Additional user behavior cognition implemented beyond this embodiment could increase and decrease the “trust” parameter accordingly. Implementation of “trust” by way of this example comprises a scale of 0 through 10 with the following discrete indications:
“Trust” equal to ten indicates that the instantiation of the cognitive data set is new (i.e., the first instantiation of the cognitive data file) and “trusted” which infers an existing instantiation is in the creator's environment or the creator has granted permission for the existence of the instantiation.
“Trust” equal to five indicates that the instantiation does not reside in the creator environment.
“Trust” equal to zero indicates distrust, an instance where an instantiation of the cognitive data set is unacceptable.

As will be readily understood by one of skill in the art, a number of parameters can be combined to reach an overall trust factor score, and a range of trust scoring systems from a simple binary trusted/not-trusted to a very precise percentage or arbitrary total score can be utilized.

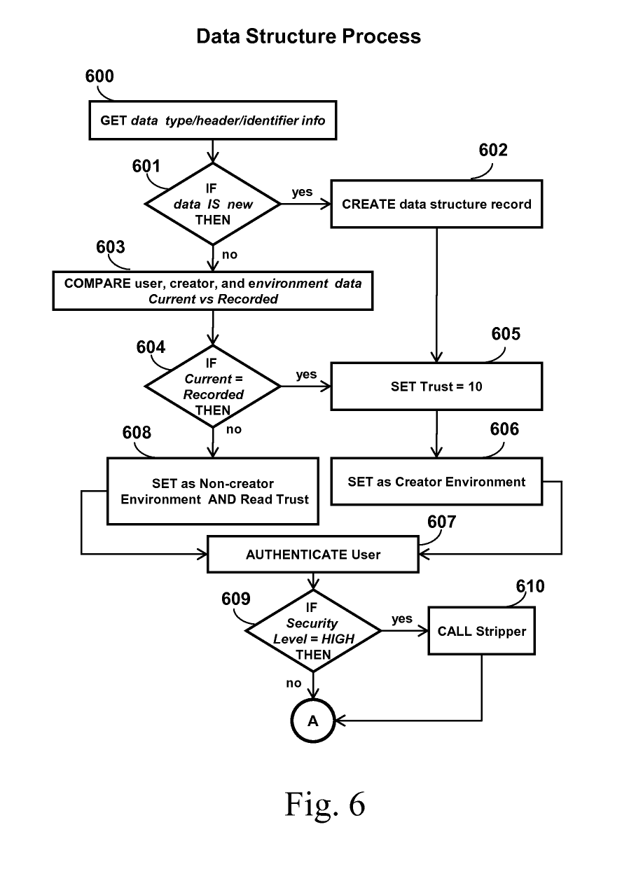

Continuing the simplified example above, according to one aspect of the inventive subject matter, the Data Structure Processor 205 creates new cognitive data and activates existing cognitive data. FIGS. 6 and 7 depict the flow diagram of the Data Structure Process 205. This process commences with reading the data structure type, header and identifier data record fields. Note that no data is present if this is a new cognitive data instantiation or file (i.e., prior to the creator's initial saving or writing of the media into the environment's memory). If the data is newly created (i.e., not saved before) 601, then the data structure record is created 602, “trust” is set to ten 605 and the current environment is set to the creator environment 606. For the case of a pre-existing cognitive data file 601, environmental data is compared to the pre-recorded data fields to determine if the environment is the same 603. If the environment is determined to be the same 604, “trust” is set to ten 605 and the current environment is set to the creator environment 606. If the environment is determined to not be the creator environment 604, then this is an instantiation of an existing cognitive data file in a non-creator environment 608 and the trust value from the stored record will be used. Once the environment and user/creator identity has been established, user authentication is performed using means such as user access passwords 607. Then a check is performed to determine if the security level is “high” 609. If the security level is “high”, the Stripper process is called 610 to access a highly sensitive associated cognitive data and further validate the user/creator.

Processing continues in FIG. 7 wherein the intelligence level is read 700 (from the prior input process 400). Processing for a plurality of intelligence levels commences with a check to determine if the intelligence level is “very smart” 701. If the intelligence level is “very smart” then the predetermined resources and data structure fields for this condition are applied to produce the cognitive data record of the type specified 702. If the intelligence level is “smart” 703 then the predetermined resources and data structure fields for this condition are applied to produce the cognitive data of the type specified 704. For the “very smart” and “smart” cases, use restrictions 706 and time/event controls are obtained either from the stored data or the user/creator 707. These input restriction preferences are used to manage and limit future use of the resulting data instantiation. And finally, if the intelligence level is not “very smart” or “smart” then “somewhat smart” resources and data structure fields are used 705.

Cognitive level resources comprise additional functionality that incorporates “how smart does the data need to be?” For example, if the creator needs the cognitive data file set to exist only during a response to an emergency incident wherein the data is being shared across government agencies to support interoperability, this data file could be constrained to self-destruct (i.e., delete the instantiation of the data set) upon the end of the interoperable communication session in which it is used. Another example may comprise an expiration time upon which the data file will self-destruct or an archive time wherein the data will automatically self-archive. Self-archiving could relate to the cognitive data file zipping itself and moving into a specific memory archive location which could be memory in the Cognitive Data Repository 204.

Commencing with the step of “set use restrictions” 706 comprises the creator indicating the resultant data file manipulation limitations such as limiting the number of times a cognitive data file can be opened, inhibiting modification (e.g., the subsequent user cannot edit the cognitive data) or setting the duration which a data file can be viewed at any time. Processing continues to obtain the environmental resource controls and accesses 708 dependent on security and intelligence levels to be employed. Then, the cognitive data record set and associated resources 709 are written into memory and the process returns to the calling procedure 710.

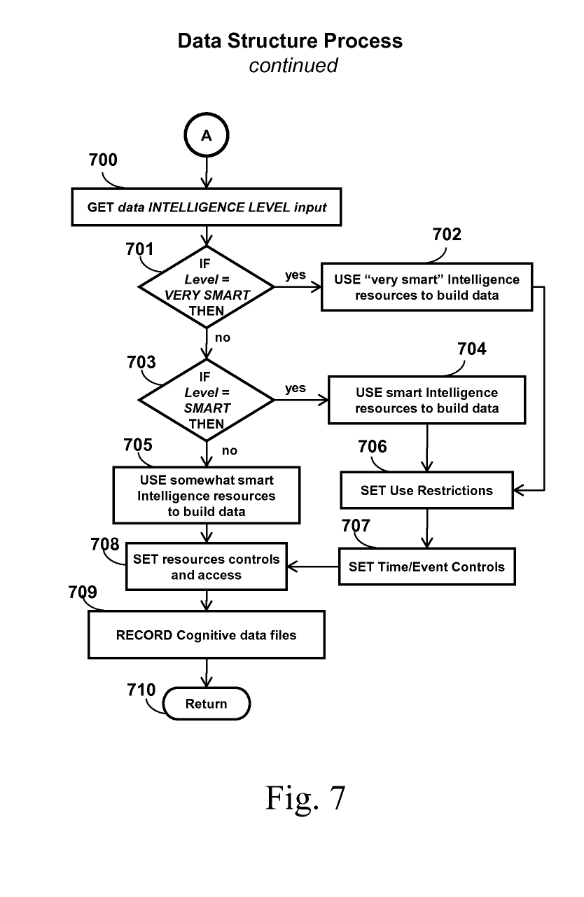

In this embodiment, “high” security level requires the use of stripping out highly sensitive data from the document data and storing it in a separate cognitive data file. Samples of highly sensitive data could comprise identity numbers such as social security numbers, names, locations, financial numbers, pricing information, etc. The Stripper process flow diagram is depicted in FIG. 8. Upon a call event 800 a check is made to determine if the data file already exists or if a new data file is being created 801. If the data file is preexisting, then optionally another user authentication process is performed 802 prior to opening the stripped data file 803 to add another layer of security. If the data is new 801 then this process obtains keyword entries from the creator via the keyboard and/or mouse 804 and writes said keywords and their associated labels into separate arrays 805 to store into separate memory. This process is iterated until all keywords and their associated labels are entered into the array 805, 806. Once completed, the cognitive data record is created for the stripped key words and another cognitive data record is created for the associated labels 807. Then the related data names are recorded 810 (the related data names will be discussed later), and processing ends 808.

The Stripper process incorporates an additional field for the creator to utilize called an associated label. As an example of the associated label, consider the instance where the creator selects “000-000-000AA”, their bank account number, to be stripped out of cognitive data being created. Along with this, the creator associates the text field: “my bank account number” as the associated label.

Using this data-to-data interrelationship permits the creator to achieve another order of security for highly sensitive data. Therefore, when viewing the final document in this example, the “my bank account number” would appear instead of “000-000-000AA” in the resulting document. Further, the data-to-data association capability can enable advanced processing.

The process flow for the “Related Data Names” fields can be supported with a process that requests the creator or user to supply names of other data files they wish to associate with the current cognitive data file, if any. This logic can also be used for “flagging” keywords in the body or context of the data file structure. This utility can be used to support advanced data-to-data analyses. By way of example, if a cognitive data instantiation contains financial fields from the prior day's revenue of a small business, if the current cognitive data file is associated to this prior data file, analyses could be enabled that calculates and derives financial conclusions.

Another example of the data-to-data analysis comprises associating and logging the stripped data to each data instantiation file name that it was stripped from and retaining a log of this association. A process can then be used to analyze and determine which data files possess the stripped data. Further analyses could be performed using these resulting cognitive data files. In this example, two cognitive data files have the same data stripped and labels were used to replace the stripped data. The cognitive data files may compare the labels that were used to determine if they can be “clustered” together, supporting a self-organizing approach to data storage and organization. This logic could be expanded further to determine if the cognitive data should be clustered as a “tightly-coupled” or “loosely coupled” relationship wherein a “tightly coupled” relationship would comprise data files that have numerous instances of commonality and a “loosely coupled” relationship is comprised of data files that have relatively few instances of commonality. The instances of commonality in this example would comprise the same stripped data. Other logic can be leveraged to support data-to-data analysis which may comprise, but is not limited to, meta data, meta tags, key data, content likeness, content similarities, etc. This data-to-data analysis supports data self-organization.

Yet another example of data-to-data analysis is where a cognitive data file accesses existing cognitive data files to determine if it should reside in the environment in which it exists. In this example, a cognitive data file may analyze a second cognitive data file by comparing the creator identity fields to determine if the owner is the same or different. If the same, the cognitive data file performing the analysis can conclude it belongs in its environment. If the owner is different, the cognitive data file becomes less confident that it should exist in its environment yielding a lower “trust” value. The concept of “trust” is detailed later in this specification. This overall logic could be applied to additional fields to support additional data-to-data analyses.

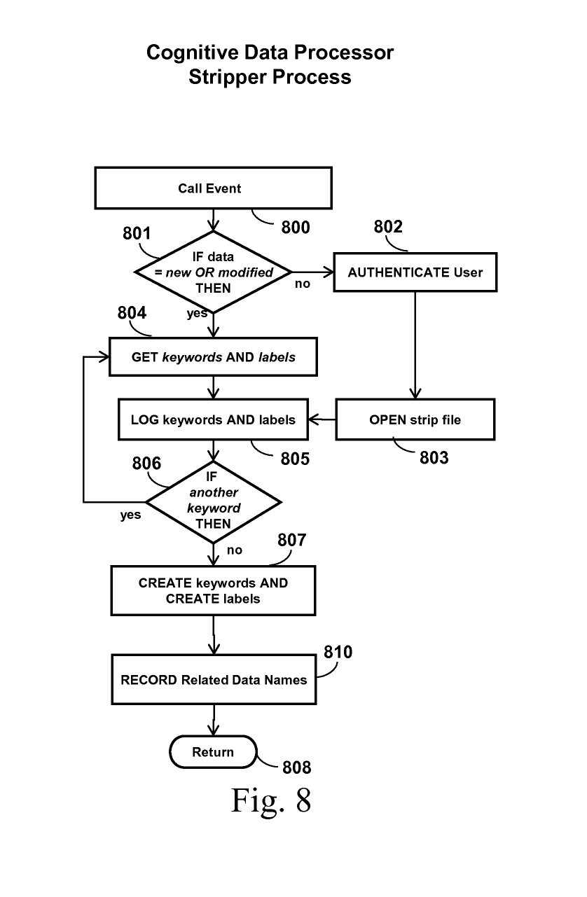

The environment needs to be controlled to protect the data. This is accomplished, in one aspect of the inventive subject matter, using the Environment process 202 flow diagram depicted in FIG. 9. The Environment process 202 is responsible for configuring the environment to protect the cognitive data. Environment controls and settings depend on the security level required while the cognitive data is in the “active” state. This process begins by obtaining the security level 900 from the Cognitive Data Processor 201. If the security level is “high” 901, then the “high” Environment Restriction 905 conditions are invoked. Restrictions to unnecessary resources are greatest for this level of security. The “high” security level in this example comprises:
Close all non-essential ports (only permit essential ports to remain open such as the keyboard, mouse, and monitor video port).
Close unnecessary active processes in the environment; shut-down processes that are activated but not needed for the creation and processing of the cognitive data. For example, a Microsoft update process, email, or Google toolbar process may be active and processing in the Random Access Memory (RAM) but are not needed for the creation and manipulation of cognitive data so these non-essential processes are terminated if the data is “very smart”.
Resources such as a printer or a database may need to be available to support the creation of the cognitive data file and these can be user selectable via a user interface so the means to access said resources and/or devices could be permitted on a limited basis dependent on creator selection.

If the security level is “medium” 902, then the “medium” environmental restrictions 903 are used. The “medium” level is not as constrained as the “high” level. More processes may be permitted to run in the background (e.g., email) and there may be more port access without the need to first close the data file (e.g., internet access). Finally, if the security level is “low” 904 then port control access could be permitted wherein slight access to an internet connect limitations could be configured (e.g., only “trusted” sites can be visited while the cognitive data is in an “active” state). Once environmental restrictions are determined based on the security level, the environment ports and accesses (e.g., remote access) 906 are set accordingly. Then processes controls 907 and resource controls 908 are configured. The environment is now secured for the “active” cognitive data to be accessed by the user/creator and this process ends 909.

Note that schemes such as “port knocking” may be incorporated to further protect the environment while the cognitive data is in an “active” state. Port knocking is used to prevent an attacker from scanning a system for potentially exploitable services thus protecting ports so they will appear closed.

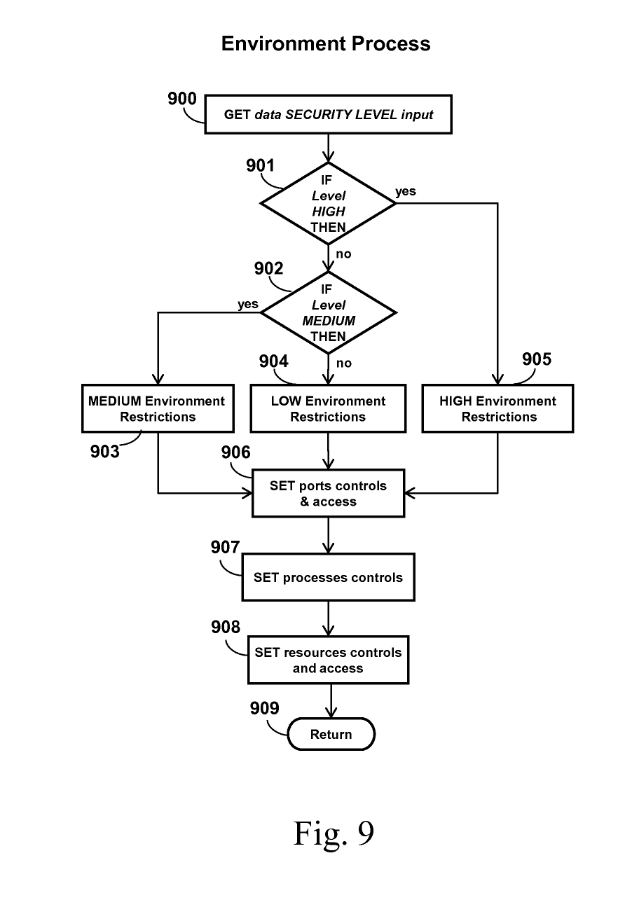

The Cognitive Data Processor 201 in this embodiment is implemented augmenting the previously described processes with a Multi-Agent System (MAS) comprising Intelligent Agents (IAs). FIG. 10 depicts fundamental elements of a simple IA wherein the Intelligent Agent 1000 program is a function that implements the agent mapping from Precepts 1001 into Actions 1007. Environment Precepts 1001 are fed into the IA's Sensors 1002. The Status 1003 is “what the world is like now” for the IA. Given said Status 1003 and applying the IA's Rules 1005, yields specific Actions 1004 taken by the IA. In a simple case, by finding a Rule 1005 that matches the current situation (as defined by the percept), perform the Action 1004 associated with that particular Rule 1005. Actions 1004 are the inputs into Actuators 1006 resulting in Actions taken for the environment of the IA. More complex IAs includes learning agents that may also be employed. The overall architecture of the Cognitive Data

Framework 200 in this embodiment is supported by a collection of these specialized Agents or IAs. Cognition is realized as a set of representations and models that interchange information between these IAs and representations. Each unit functions as a cognitive mechanism to achieve a particular aspect of intelligence, such as upon perception of an event, select appropriate action(s), etc.

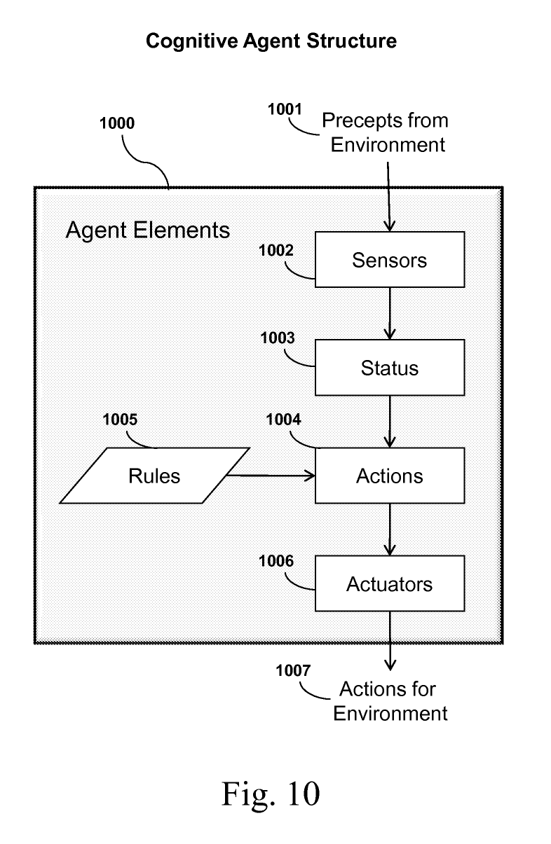

The MAS for this cognitive data invention according to one aspect of the inventive subject matter is depicted in FIG. 11. A primary purpose of the MAS is to ensure the cognitive data file itself is not compromised. This MAS is comprised of a plurality of IAs that reside in the cognitive data record and/or set of records. The Watcher IA 1101 monitors environment actions 1100 as they relate to access and manipulation of cognitive data, the cognitive data repository, and memory. The Tracker IA 1102 logs all events that transpire with the cognitive data. The Tracker also interfaces with the Behavior IA 1108. The Behavior IA 1108 performs behavior analysis wherein behavior analysis can be of environment events, user behavior, data-to-data behavior, etc. The Health IA 1103 determines the “state of health” of the cognitive data file set and controls the existence of the particular instantiation of cognitive data. The Snitcher IA 1104 gathers information and reports back to the cognitive data creator. The Snitcher enables creator control of their data even in a compromised situation. The Watcher Agent 1100, Tracker Agent 1101, Behavior Agent 1108, Health Agent 1103 and Snitcher Agent 1104 are embedded IAs that co-exist in the same physical file or record as the Cognitive Data Structure 1105. The Approver IA 1107 reports to the creator and/or user. Along with reporting, it also provides the means to interact with the creator and/or user to manage and control the associated cognitive data.

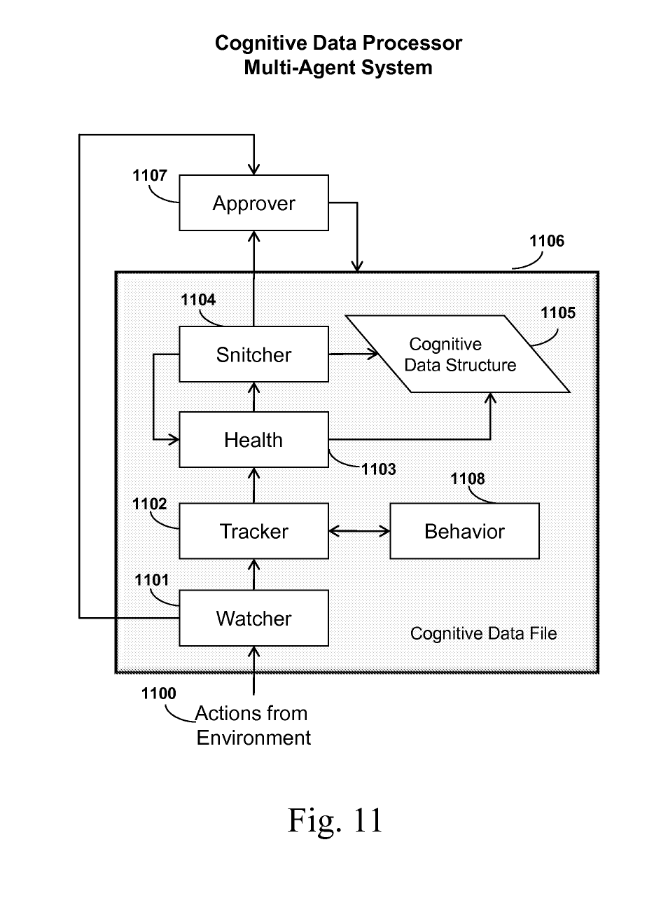

FIG. 12 depicts one aspect of the inventive subject matter in which the Watcher IA process flow diagram. The primary purpose of the Watcher IA 1101 is to monitor and detect a change in the state of the cognitive data file 1106. The Watcher cognitive Data state is initially set to “dormant” 1200. Monitoring of the digital computer environment user input means (i.e., IA sensors 1002) commences. The Watcher Agent sensors comprise input/output capabilities such as the keyboard, mouse, port communication, and operating system commands. Precepts 1001 from the environment comprise user requests such as the following:
Open (active state)
Print (moving state)
Edit (active state)
Delete (active state)
Save (active state if re-saving new instantiation of same data file set; moving state if saving a completely new instantiation of the data file set)
Copy (moving state as it is a completely new instantiation of the data file set; this is also representative of transmission, as a new instantiation of the data file set is created in the receiving environment)
Move (moving state)
View (active state)
Analyze (active state)
   Assuming an initial dormant state and upon the user selection of the cognitive data file (e.g., “open” the cognitive data file selection detected via a “click” of the mouse input device), the status 1003 of the cognitive data file is state change is detected 1202 and the status is changed to “active” 1203. The IA's Action 1004 upon the cognitive data file becoming “active” is to call the Tracker IA 1206 (which will log this event). The following Rule 1005 applies:
IF state=active THEN call Tracker (current_state, user_request);
   wherein the actuator 1006 calls the Tracker IA 1206. The resulting actions for Environment 1007 comprise invoking the Tracker IA 1206 and passing the current_state data and user_request parameters as process arguments. Processing returns to monitoring for a change in state of the cognitive data file 1208, 1202. Conversely, if the state change detected is to the dormant state 1202, then the Watcher 1101 status is maintained as “dormant” 1204 and the process returns to monitoring the cognitive data file for state changes 1208, 1201. Finally, if the status change has been detected 1202 to “moving” 1205, then the rule 1005 is as follows:
IF state=moving THEN call Approver (current_state, user_request_type);

wherein the actuator 1006 calls the Approver IA 1207, 1007. The results of this function provide a means to an alert to the user to a “move data” request type. Upon processing returning to the Watcher Agent process, the environment resources that accessed the cognitive data need to have the temporary memory “wiped” or written over 1208 so that stored highly sensitive data such as access codes and keys are protected, thus completing the process 1209.

Primarily, the Approver IA 1107 performs authentication checks and accommodates creator action approvals. Precepts come from the Snitcher 1104 and the Watcher 1101. The cognitive data file or cognitive data record fields except the actual data body comprise the Sensors 1002 (i.e., metadata) and their values constitute the Status 1003. Actions taken are dependent on the Rules 1005 which can comprise the following:

IF security acceptable THEN permit user_request

IF security somewhat acceptable THEN notify Snitcher

IF security NOT acceptable THEN deny user_request_type AND Notify Health

wherein “security acceptable” equates to the current environment settings matching or exceeding the security level data value in the cognitive data record and the trust value; “security somewhat acceptable” is dependent on Snitcher logic (to be discussed later); and “security NOT acceptable” equates to the current user identity not matching the creator identity and the absence of a sense of “trust”.

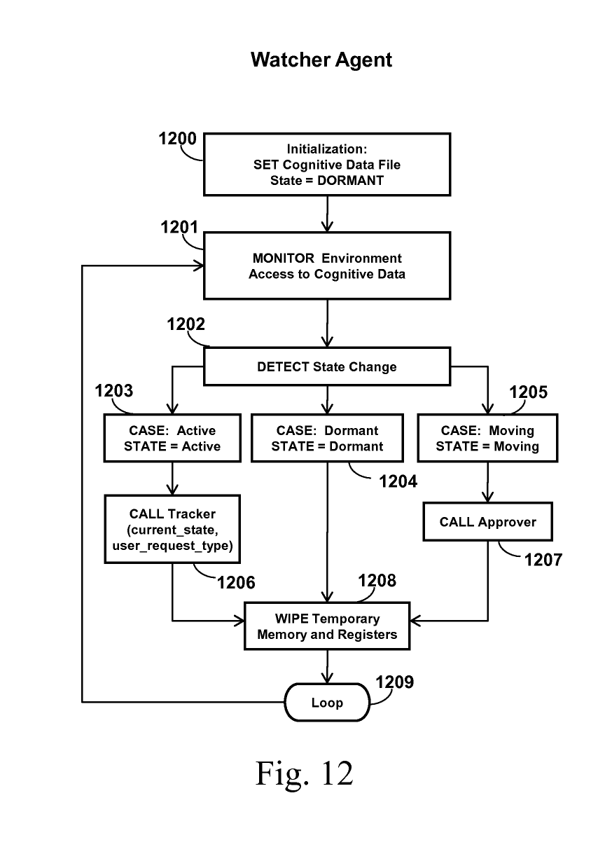

FIG. 13 depicts one aspect of the inventive subject matter in a flow diagram to further explain the Approver Agent 1107 as it relates to the Watcher Agent 1101 Precept 1001. Processing commences upon receiving a call from the Watcher Agent 1300, 1101. A check is performed to determine if the current user is the creator of the cognitive data file 1301 by comparing the cognitive data record creator identity fields with the current user identity fields. If the creator identity equals the user identity then a check is performed to determine if the user_request_type is permitted 1302 based on the stored cognitive data record field settings. If the user_request_type is permitted 1310 the Access process is called passing the user_request_type argument 1310 and the process terminates. However, if the user_request_type is not permitted then the user is alerted of the action attempt 1303 and that the action is not permitted thus the request will be denied 1304. This is followed by calling the Tracker Agent 1305, 1102 to log this event ending the process 1311. Conversely, if the user_request_type is permitted 1302 then the user_request_type is permitted and processed 1310.

For the case wherein the user identity is not the same as the creator identity 1301 then the “trust” field is used. “Trust” is the measure in which the Approver can determine if an cognitive data record set instantiation is acceptable to the creator. This gives control to the creator of the cognitive data set. If the current user of the cognitive data is not the creator 1301 then, a check is made to determine if “trust” is equal to ten, i.e. high trust 1313. If “trust” is equal to ten 1313 then, processing commences to determine if the user request type is permitted 1302 as already explained. If “trust” is not equal to ten 1312 then, the Health Agent is called 1312 ending the process 1311.

The purpose of the Snitcher 1104 is to report to the creator of the cognitive data file set. By way of example, examine the case wherein the cognitive data record is resident in a receiver environment 104. Then, conditions may exist where the Snitcher 1104 infers a breach. This event needs to be reported to the creator. This way, the creator can become apprised as to who has a copy of their cognitive data file (the receiver environment and user identity), obtain a copy of the events log(what the receiving party has done with the data), and influence the health of the particular instantiation cognitive data record.

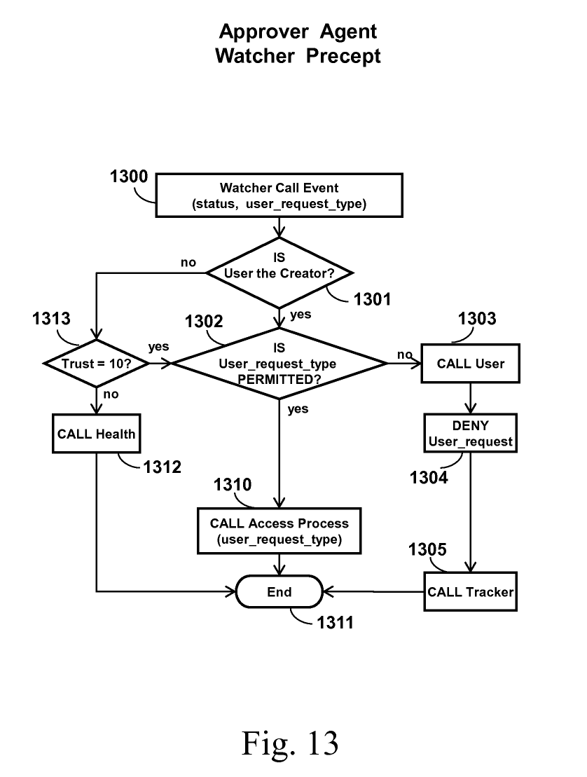

With this in mind, FIG. 14 depicts the flow diagram for one aspect of the inventive subject matter in which the Creator's Approver Agent 1107 process upon receiving inputs from an instantiation of the Snitcher Agent 1104 precept 1001 is examined. Note that this Snitcher Agent does not initially reside in the creator's environment but with the instantiation being processed. Processing commences upon reception of a Snitcher Call Event 1400. The Approver 1107 reads the user identity data 1401, the health data 1402, and the Tracker event log data 1403. Note the Tracker event log data will be appended if the size becomes too large to embed in the Snitcher. The Snitcher size needs to be feasible for transmission, although the file size can be decreased by a process such as data compression. The creator may be alerted via a message, for example printed to the creator's screen, that another instantiation of the cognitive data file exists 1404 wherein the creator is presented the option to indicate this condition is acceptable or not 1405. Another method for this processing step may be to log and record approved users of the cognitive data set so the creator does not have to physically process this acknowledgement. If the instantiation is approved by the creator or from an approved user list, then the Snitcher is returned with “trust” set equal to ten, i.e. high trust 1406 and the process ends 1407. If the creator selects the option of further examining the incident 1405, then the log information and record data are displayed for the creator to examine 1408. Once examined, the creator is again presented with the option 1404 to indicate acceptance or not 1405. If the creator determines that the instantiation of the cognitive data file possessed by the user reported is not permissible, then “trust” is set to zero in the Snitcher and this value is returned 1409 ending the process 1407.

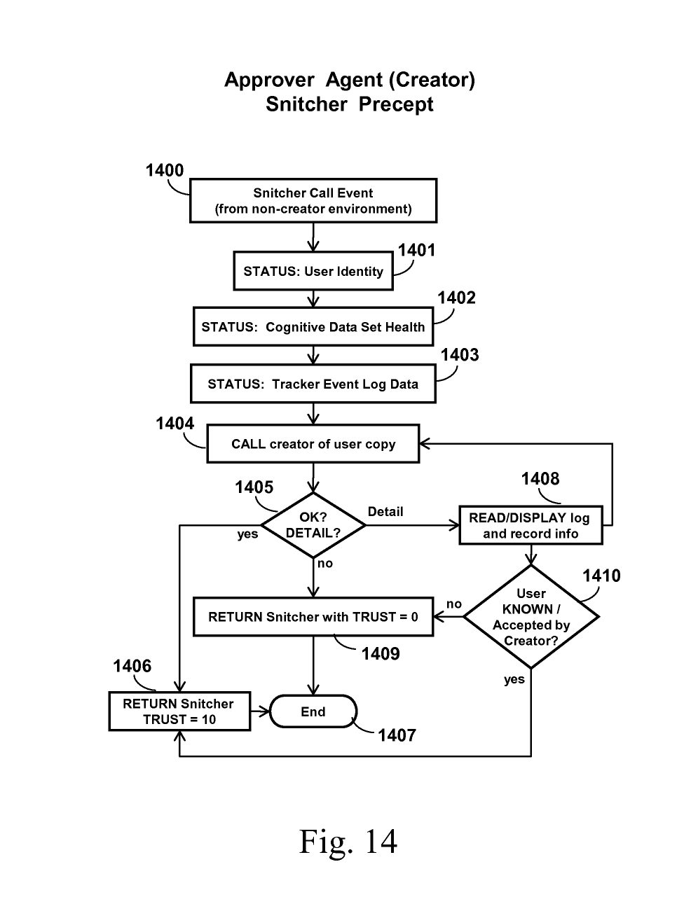

The Snitcher Agent 1104 precepts 1001 are received from Approver Agent 1107 and Health Agent 1103. The Snitcher Agent 1104 reports back to the creator Approver Agent 1107 instantiation upon detection the cognitive data set residing in a non-creator environment. The Snitcher Agent 1104 instantiation reporting back to the creator Approver Agent 1107 provides a means of control for the creator for events such as misappropriated or breached data. This gives the creator a means to learn that said data is misappropriated, obtain the identity of the misappropriator, and have a capability to attempt removal of said breached data. According to one aspect of the inventive subject matter, FIG. 15 is a process flow diagram of the Snitcher Agent for the Approver Agent 1107 precept. Processing commences upon the event of the Snitcher Agent being called by the Approver Agent 1500. For the case of “trust” equal to zero 1501 the Health Agent is called 1502 to delete the instantiation of the cognitive data. For the case where “trust” equal ten 1503, the Health Agent is called 1504 accepting the instantiation from the creator. This event of the Snitcher contacting the creator may be removed from the tracking log 1505 then, the process is terminated 1506.

Note that the Snitcher Agent needs to be transmitted between the creator environment and a non-creator environment where the instantiation of the cognitive data set resides. This can be accomplished by opening the network port of the current environment and sending the Snitcher to the creator environment network identity, internet protocol address and computer identity. The Snitcher Agent possesses the Tracking Agent log data that can be leveraged along with the last known Snitcher environment readings (just prior to Snitcher transmission) to return the Snitcher back to the non-creator environment.

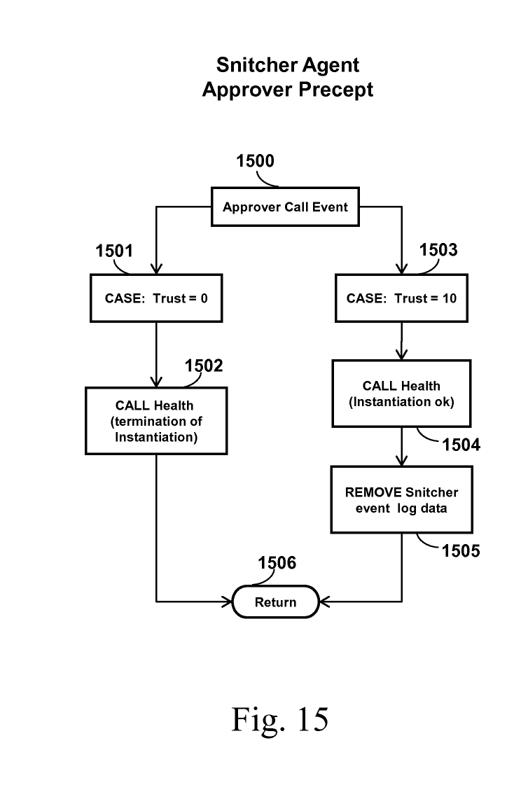

Next, the Snitcher Agent for the Health Agent 1103 precept process flow diagram in FIG. 16 is examined. Processing commences upon a Health Agent 1600 call event. For the case of “trust” equal to zero 1601 the Approver Agent is called 1602 to notify the creator that the misappropriated instantiation of the cognitive data has been deleted and the process ends 1609. For the case where “trust” equal five 1603, the Approver Agent is called 1604 to determine if the cognitive data instantiation is acceptable to the creator. A check is made to determine if a response is received from the creator 1605. If the creator responds, the “trust” value provided in the creator response is read 1606 and the Health Agent is called passing along the “trust” value 1607 for further processing. If the creator has not responded 1605 within a specified period of time then, the user request is denied 1608 and the process is terminated 1609.

Note that additional processing may be implemented for the step of receiving an acknowledgement from the creator 1605 such as inserting a timer in the process. Said timers could be used in such a way as to continue the processing after a specified time lapse upon lack of creator acknowledgement reception. Additionally, the creator environment could implement a log of user identities that are permitted to possess an instantiation of the cognitive data to automate this process.

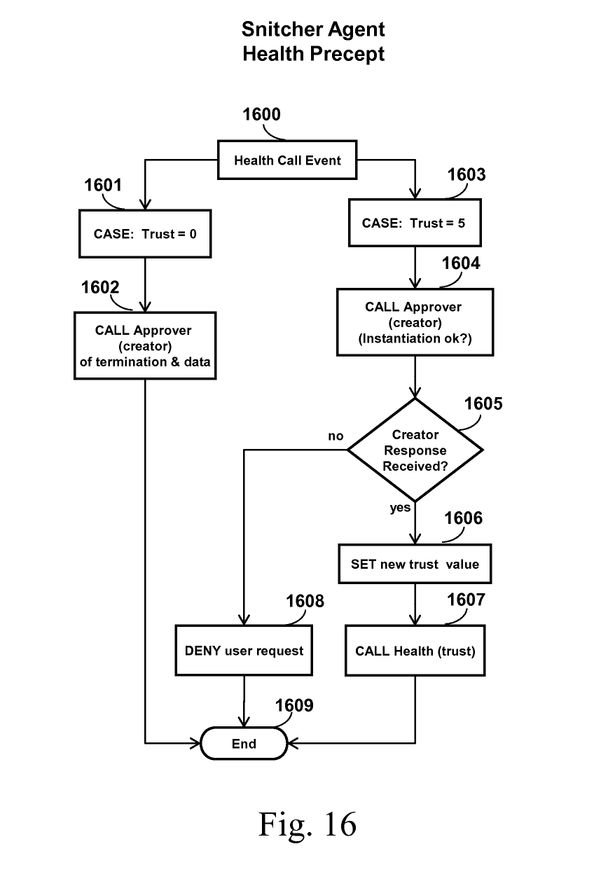

The Health Agent determines if the data is secure and protected or in a compromised situation. It can also determine the life of the data and cause the cognitive data to self-destruct. This is accomplished by monitoring the “trust” value and processing time functions based on restrictions decided by the creator. According to one aspect of the inventive subject matter, FIG. 17 depicts a flow diagram for the Health Agent 1103. Processing commences upon receiving a call from a precept with a value for the “trust” parameter 1700. The precepts for the Health Agent comprise the Snitcher, Tracker and Approver. A check is performed to determine if the “trust” value is equal to ten, i.e. high trust 1701. If the “trust” value is equal to ten then the data timer is checked 1704 against the current date/time. Another check is made to determine if the cognitive data has expired 1705. If expired, the data is deleted and the process ends 1708. If not expired 1705, then a call is made to the Access Process passing the “user_request_type” upon which this process ends 1708. Note that this additional cognition is achieved for the “smart” and “very smart” cases wherein the “life” of the data can be determined based on an event or time.

The Tracker Agent 1102 records all log data for the cognitive data file thus maintaining an event history of all events that occur with the cognitive data file. This is extremely valuable upon a security breach as it enables traceability. An advanced implementation of the Tracker could include reporting incidences in real-time to security or other third party software such as virus or firewall protection software.

Advanced cognition implementations can optionally be incorporated into the inventive systems, methods, and apparatus. One valuable capability is to provide behavior cognition. An implementation may possess multiple Behavior Agents wherein these agents support particular behavior analysis. By way of example, user behavior cognition can be implemented wherein the cognition can make an inference regarding appropriate use of the data. This capability could aid in detection of employee misconduct and unintentional actions that are the greatest cause of data security breaches. This capability thus could help the user and the enterprise maintain security inside the enterprise.

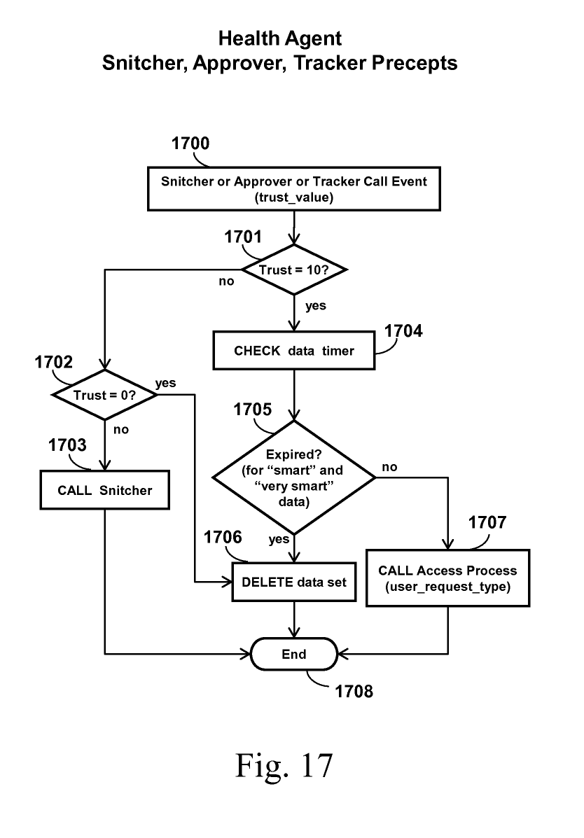

Consider the example of an enterprise employee that uses a notebook computer to work on the premises and at various remote locations. Begin by examining the flow diagram for the Tracker Agent 1102 with the Watcher IA 1101 precept in one aspect of the inventive subject matter depicted in FIG. 18. Processing commences upon receiving a call from the Watcher Agent to log an event 1800 upon which a new entry into the cognitive data record log fields is recorded along with the user virtual log data fields 1801. The Behavior Agent is called 1802 (which will be discussed later). Recall that the log data is comprised of all the data structure fields except the “body” field. In this example, the user virtual log data fields records usage of an enterprise notebook computer relative to the employee's work schedule and any a priori data. Virtual log fields are as defined below:
User virtual log [(vs) (s) (ss) all fields] (note: this field records notebook computer use at an enterprise and at remote locations)
   Enterprise environment use log
      Activated
      Terminated
      Throughput usage
   Remote environment use log
      Activated
      Terminated
      Throughput usage
   Schedule (employee entry and confirmed based on prior use analysis)
      Work location
      Remote location(s)
      Travel location(s)
      Hours (daily schedule)
      Duration
      Cognitive data access history (note: Age data from the cognitive data structure compliment this field)
         Location
         Name of data record
         Frequency
         How often
            The Behavior Agent returns with a “trust” value which is read 1804. Then, the Health Agent 1103 is called passing the “trust” parameter 1805 ending the process 1805.

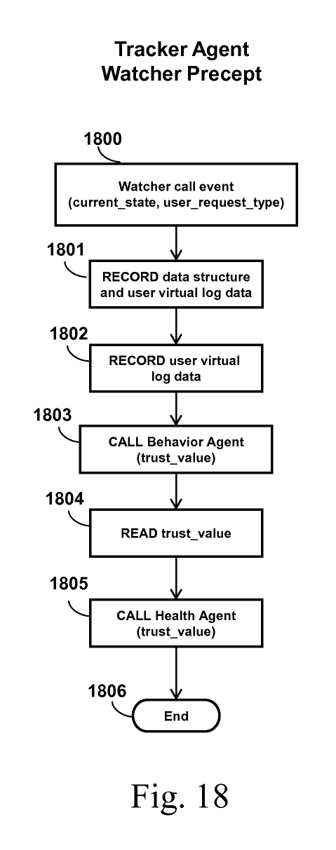

In one aspect of the inventive subject matter, the Behavior IA 1108 process flow diagram is depicted in FIG. 19 determines if the user (i.e., an enterprise employee) can gain access to user requested cognitive data from an enterprise environment. Assume enterprise security policy applies the following rules:
Access to “high” and “medium” security level data restricted to the enterprise environment AND only during normal work hours, and
Access restricted to “low” security level data restricted to the enterprise environment AND during normal work hours AND after normal work hours.
   This security policy can be automated by implementing this rule-based logic. Processing commences upon a Tracker call event 1900. A check is made using the log data and data structure metadata to determine if the user_request for cognitive data access being invoked in the enterprise environment is during the user's normal work schedule 1901. Logic to create rules may for example comprise:
Schedule IS Monday through Friday AT Enterprise
Time_of_day_Schedule IS 8 a.m. UNTIL 5 p.m.
normal work IS during Schedule AND Time_of_day_Schedule
   If yes 1901, then another check is made to determine if the access request is typical user behavior 1902. To determine this, consider the simple case of reading the frequency field of the User Virtual log wherein a flag is updated per iteration of user access to the data instantiation. A sample of logic to build rules for the “typical user behavior” would be as follows:
IF frequency IS GREATER THAN 2 AND how_often IS GREATER THAN twice_a_day THEN user_behavior EQUAL TO typical
ELSE user_behavior EQUAL TO not_typical
   A priori log events can be used to determine if the user has accessed this data before. If the user behavior is determined to be “typical” then “trust” is equated to ten 1903 and the process ends 1904. If the user behavior is “not typical” 1902 then “trust” is equated to zero 1906 and the process ends 1904. For the rest of the security policy, if the current time does not fall during the normal work schedule 1901, then another check is made to determine the security level 1905. If the security level is low, then “trust” is equated to ten 1903 and the process ends 1904. However, if security is either “high” or “medium” then “trust” is equated to zero 1906 and the process ends 1904. Similar logic can be applied for the case of the employee working remotely (i.e., the notebook computer requesting access is not at the enterprise location). If the user is determined to perform breach or erroneous behavior, the creator is notified.

This capability can be valuable for corporate or government agency environments that must ensure data security from insider theft. Enterprise-wide anomaly behavior can also be implemented such as an insider attempting to copy a whole directory of data. An enterprise policy can disallow a user to copy multiple data files that exceed a fixed amount. Thus a data-to-data analysis can be performed wherein the cognitive data file can determine how many other data files have been written into the directory the user is attempting to store into said directory. Upon counting up to the fixed amount or upon concluding that the user is behaving suspiciously, the cognitive data file can self-destruct and/or send an alert to the enterprise data security administration. This enables the cognitive data to provide a situational awareness capability. This capability can help mitigate potential insider theft of data.

Another approach to software implementation is to create an adaptive capability, adaptive cognitive data, by employing Artificial Intelligence (AI) techniques and algorithms. These implementations replace or augment von Neumann processing disclosed earlier. Additional functionality and enhancements can be implemented based on how intelligent the creator desires the cognitive data to become, how adaptive does the cognitive data need to be, and what additional knowledge should the cognitive data have to meet the creator's needs.

For those skilled in the art, AI can be implemented throughout the MAS. By way of example, consider the determination of “trust” wherein the cognitive data reasons “do I trust the user?” This adaptive reasoning can be implemented using a discipline of AI called Fuzzy Inference (FI) logic which possesses the antecedents of the user's work schedule, the user's current environment location, and the user's historical use of the cognitive data instantiation. The following parameters are needed to use the FI system:
Time-of-day
User's daily work schedule hours
Environment current IP address/network identification data
Environment past IP addresses/network identification data
Frequency and duration of user accessing cognitive data
User's access data
   The FI system can process these inputs to determine the level of trust wherein trust is the output of the FI system. As above, and as will be readily understood by one of skill in the art, a number of parameters can be combined to reach an overall trust factor score, and a range of trust scoring systems from a simple binary trusted/not-trusted to a very precise percentage or arbitrary total score can be utilized. In the present example, the FI crisp output values for trust are X(0, 5, 10) complying with the logic disclosed herein.

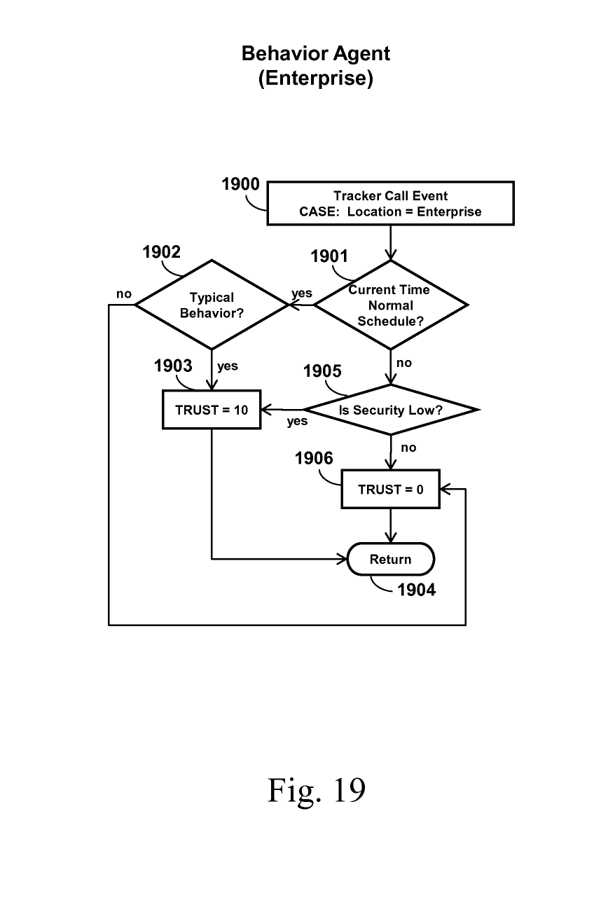

According to one aspect of the inventive subject matter, the FI membership functions are provided in FIGS. 20, 21, and 22. The degree of membership of these functions range from Y(0, 1). In FIG. 20, the work schedule membership classifies the membership functions based on the user's work hours (i.e., time of day). The function from 12 a.m. until around 6 a.m. classifies a “not normal work time early in the day” 2001; around 7 a.m. until around 6 p.m. is classified as “normal work time” 2002; and after around 6 p.m. is considered “not a normal work time late in the day” 2003.

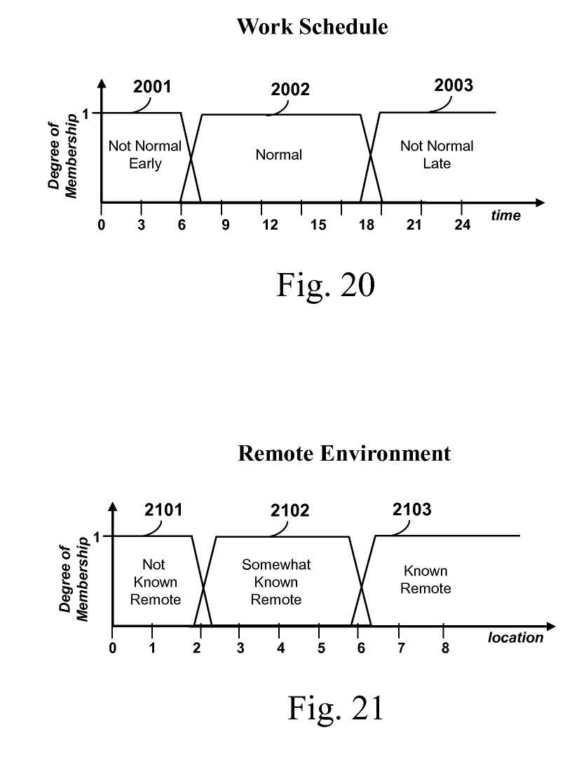

FIG. 21 implements one aspect of the inventive subject matter in which the cognitive data's inference about its environment location based upon a priori data on the location and frequency of the user's access from that location. The first function 2001 represents not recognizing the remote user environment (i.e., by checking the IP address and network information and not finding it in the event log). The membership function represents the remote location has never been used before and until the location has been used a couple of times 2101. Once used on additional occasions, for about two to five times, the data “somewhat knows” the remote environment 2102 (per the membership function representation). If the user continues to repeatedly utilize the remote location after five times, the environment becomes “known” to the data 2103. Note, if the location is at the enterprise where the user works, the data file “knows” the environment 2104 which is an inferred membership function as the frequency of use should be a high number.

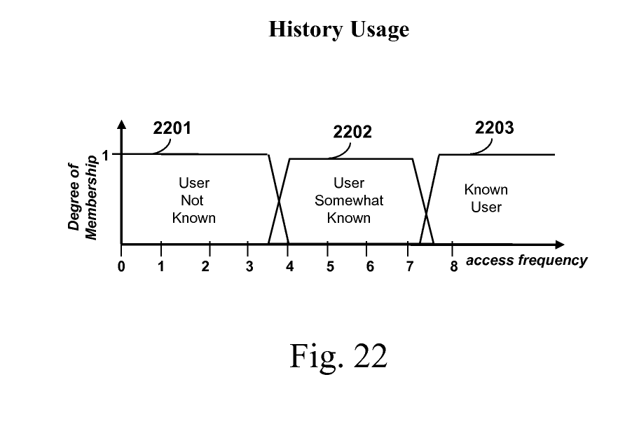

FIG. 22 implements one aspect of the inventive subject matter in which the cognitive data's membership functions about how well the data knows the user. This is based upon the frequency of the user accessing the data. The data does not consider the user “known” if the user has accessed it less than around four times 2201; the data considers the user “somewhat known” if the user accesses the data around four to seven times 2202; and the data considers the user “known” if the user accesses it more than around seven times 2203. These FI antecedents are used to apply the following rules:
IF normal_time AND environment_not_known_remote AND user_known THEN trust=5;
IF normal_time AND environment_somewhat_known_remote AND user_known THEN trust=5;
IF normal_time AND environment_known_remote AND user_known THEN trust=10;
IF normal_time AND environment_enterprise AND user_known THEN trust=10;
IF not_normal_early OR not_normal_late AND environment_not_known_remote AND user_known THEN trust=0;
IF not_normal_early OR not_normal_late AND environment_somewhat_known_remote AND user_known THEN trust=5;
IF not_normal_early OR not_normal_late AND environment_known_remote AND user_known THEN trust=10;
IF not_normal_early OR not_normal_late AND environment_enterprise AND user_known THEN trust=10;
IF normal_time AND environment_not_known_remote AND user_not_known THEN trust=0;
IF normal_time AND environment_somewhat_known_remote AND user_not_known THEN trust=0;
IF normal_time AND environment_known_remote AND user_not_known THEN trust=5;
IF normal_time AND environment_enterprise AND user_not_known THEN trust=5;
IF not_normal_early OR not_normal_late AND environment_not_known_remote AND user_not_known THEN trust=0;
IF not_normal_early OR not_normal_late AND environment_somewhat_known_remote AND user_not_known THEN trust=0;
IF not_normal_early OR not_normal_late AND environment_known_remote AND user_not_known THEN trust=0;
IF not_normal_early OR not_normal_late AND environment_enterprise AND user_not_known THEN trust=0;
IF normal_time AND environment_not_known_remote AND user_somewhat_known THEN trust=0;
IF normal_time AND environment_somewhat_known_remote AND user_somewhat_known THEN trust=0;
IF normal_time AND environment_known_remote AND user_somewhat_known THEN trust=5;
IF normal_time AND environment_enterprise AND user_somewhat_known THEN trust=10;
IF not_normal_early OR not_normal_late AND environment_not_known_remote AND user_somewhat_known THEN trust=0;
IF not_normal_early OR not_normal_late AND environment_somewhat_known_remote AND user_somewhat_known THEN trust=0;
IF not_normal_early OR not_normal_late AND environment_known_remote AND user_somewhat_known THEN trust=5;
IF not_normal_early OR not_normal_late AND environment_enterprise AND user_somewhat_known THEN trust=10;

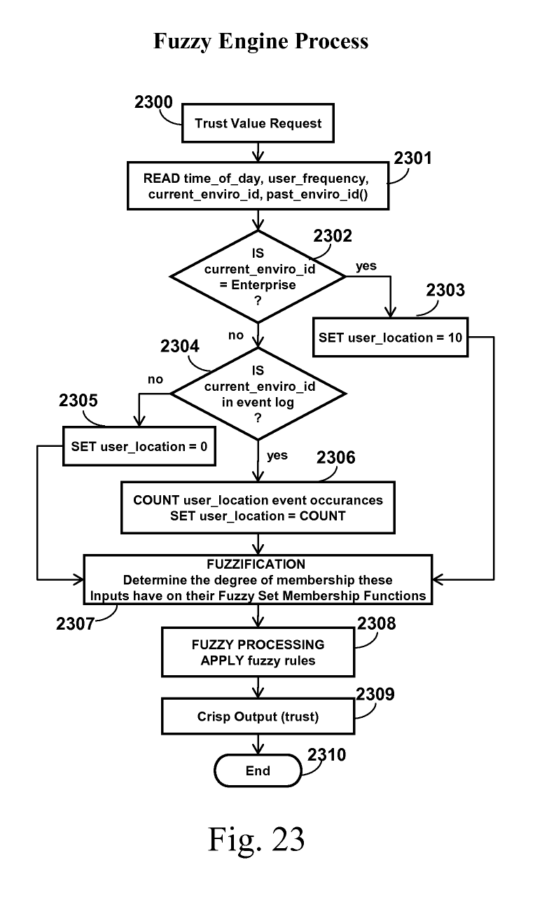

FIG. 23 depicts one aspect of the inventive subject matter in which the flow diagram of the unique processing required to support FI processing. It is noted that the same initial processing flow as depicted in FIG. 11 is employed to monitor for a change of state event. Subsequently, upon a determination of “trust” the FI processing of FIG. 20 can be invoked wherein the processing begins upon a request to determine “trust” 2300. The time_of_day is read from the environment's system clock; user_frequency of the user accessing the data is read from the virtual log; current_environment identifying information is read; and past instances of the current_environment logged into the event log is summed 2301 to obtain the crisp inputs into the FI system.

A check is made to determine if the current environment identification is located in the enterprise facility network 2302. If the identity is affirmed to be at the enterprise then the user_location value is set to 10, 2303. If not, another check is made to determine if the current environment is in the event log 2304. If the event log produced zero events of the user's current environment then the user_location is set to zero 2305 indicating that the environment is not known to the data. Otherwise, the sum total of times the user accessed the data in their current environment is set 2306.

The time_of_day, user_location, and user_frequency are the crisp inputs into the fuzzification process 2307 wherein the FI membership functions are generated. Then the FI Rules are applied 2308. The rule that yields the strongest result is considered the consequential functional operator determining the value for “trust” 2308. Once the strongest rule is applied, the crisp value for “trust” is obtained 2309 and the process ends 2310.

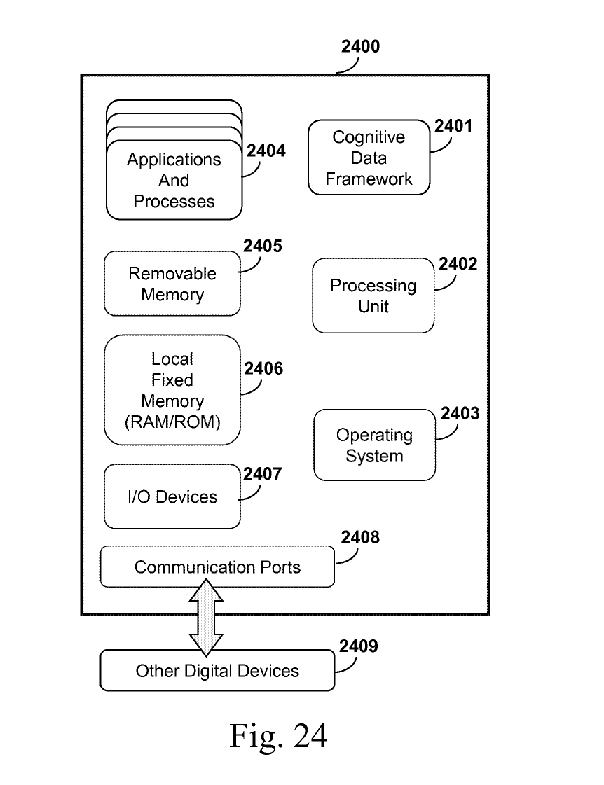

For the purpose of discussion, and not for the purpose of limitation, FIG. 24 depicts one aspect of the inventive subject matter in which a high level hardware implementation of the FIG. 2 cognitive data system. A digital computational system 2400 employs a processing unit 2402. Utilization of a processing unit 2402 for this type of application is a typical solution/implementation. However, the functions indicated in FIG. 2 can be integrated together or packaged separately in numerous configurations. These configurations can range from microcontroller units to Personal Computer systems, enterprise workstations, servers, gateways, network systems, and/or other hardware that accepts and processes data.

With reference to FIG. 24, in one aspect of the inventive subject matter, one exemplary system for implementing the disclosed embodiment includes a computing device, such as a digital computing device 2400. It is intended that the digital computing device comprise any digital device that is used to process data which comprises but is not limited to a computer, a mobile device, a server, a network device, a communications device, remote access devices, wifi devices, enterprise computing devices, cloud computing devices, etc. A basic configuration of the computing device 2400 comprises at least one processing unit 2402, optional removable memory 2405, local fixed memory 2406 which comprises Random Access Memory (RAM) and Read Only Memory (ROM) and hard drive system memory. System memory configurations vary but typically include the memory elements stated. The computing device also includes an operating system 2403 and a plurality of applications and processes 2404. The computing device 2400 may also comprise input/output (I/O) device(s) 2408 such as keyboard, mouse, pen, and voice input device, touch input device, a display, speakers, printer, etc. Other digital devices 2409 interface with the computing device 2400 via the computing device communication ports 2407. These additional data storage devices (removable and/or non-removable) may comprise for example, magnetic disks or optical disks, printers, modems, etc. Computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 2400. Any such computer storage media may be part of device 2400.

To clearly describe the hardware support functions required for the cognitive data system 2400 of FIG. 24, the following example of the steps performed upon utilizing the cognitive data framework is explained along with details as they relate to the hardware. The cognitive data system, method, and apparatus 2400 comprises software coded according to the flow diagrams of FIGS. 3-18. This software code is stored in memory within controller 2400 in one embodiment. When executed by processing unit 2402, this software causes the processing unit to implement the steps set forth in the flow diagrams of FIGS. 3-18. Data is accessed and stored utilizing the removable memory 2405 and/or local fixed memory 2406 to execute cognitive data framework application software 2401, as well as other applications, and processes 2404 (e.g. other software applications such as Windows Explorer, Microsoft Office software, etc.). The cognitive data framework may be implemented as a “standalone” software application or be “a plug-in”. If the cognitive data framework is a “plug-in” the capability would be accessed via other third-party software applications 2404. For example, if the cognitive data framework application is a “plug-in” for the Microsoft Word processing product, it could provide the functionality disclosed herein offering an cognitive data option to the user.

The operating system 2403 translates the software into executable code that causes hardware of the system 2401 and other devices 2409 to respond and function in accordance to said executable code Other digital devices 2409 connect to the system 2400 via communication ports 2408 using hardware or wirelessly. The cognitive data framework software 2401 monitors the hardware input/output ports 2407, such as a keyboard and/or mouse, for creator or user selection. Upon receiving a creator or user request from an input/output device 2407, the cognitive data framework software 2401 is invoked. The RAM/ROM 2406 provides the memory necessary to support the load of the executable code and memory to support the real-time processing. The processing unit 2402 executing the cognitive data framework code 2401 accesses the data storage memory 2405 to support software executions. In one embodiment, the cognitive data resources and repository is used to store cognitive data and resources as a section of memory 2406. Upon sensing creator or user selection, the state of cognitive data stored in memory 2406 or other digital device memory capabilities 2409, changes from dormant to “active” or “moving”. The computational environment configuration is compared and configured in accordance to the configuration indicated in the stored cognitive data record fields and metadata to support the intelligence level and security level indicated by said stored cognitive data. To achieve these levels of security and intelligence, resources may be shut-down or activated accordingly (e.g., the internet port 2408/2409 may be shut down to achieve the indicated security level required to activate and access the stored cognitive data file resources). Ports are subsequently managed (i.e., opened and closed) to transmit software from one environment to another as is the case for transmission of the Snitcher software from a receiving environment to the creator environment and back thus providing remote control for the creator of an instantiation of their data in a non-creator environment.

Additionally, the cognition of a cognitive data instantiation optionally also comprises anti-reverse engineering, anti-debugging, and/or anti-tampering capabilities.

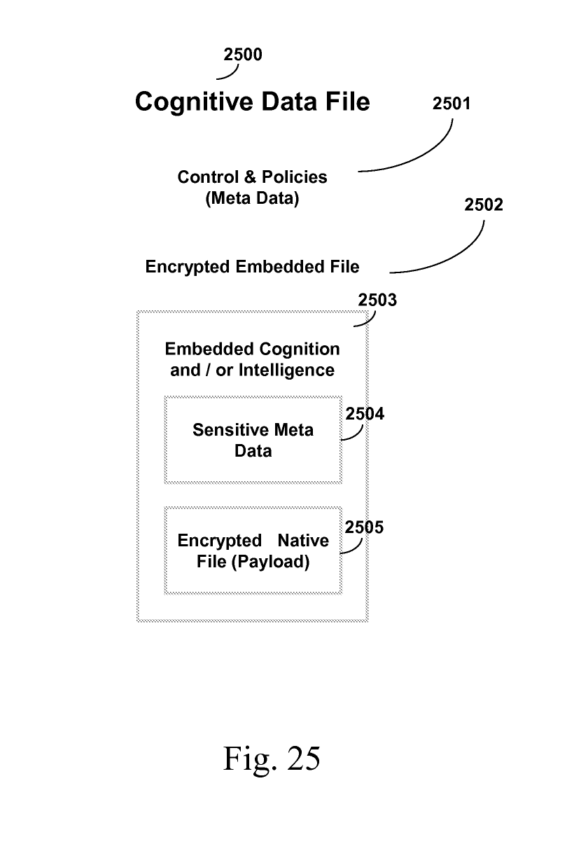

An implementation of the disclosed technology can also be performed by taking an existing digital file type 2505, encrypting it as well as any optional sensitive meta data 2504 and then “wrapping” it with the embedded functions 2503 as shown in FIG. 25. This can be further extended to encrypt 2502 the resulting wrapped file 2503 while extracting any meta data that can be used along with policies and support controls of the payload 2501 which results in another form of the cognitive data file 2500. Variations or combinations of these elements can be used to create a cognitive data structure, a data file type, encryption/decryption keys, digital signatures, certificates, message authentication codes, and/or non-real-time/near-real-time/real-time data structure types.

In summary, in one embodiment the disclosed methods, systems, and apparatus advantageously reduces user's exposure to undesired and malicious activity by employing advanced control mechanisms implemented at or near the computational device. The cognitive data methodology, system, and apparatus permits the consumer to proactively take control of whom, how, when, and if another party may possess their data. Advantageously, the disclosed methodology transforms data from a passive file, encryption key, or data structure such as a protocol that can be obtained, compromised and misused by anyone to an adaptive cognizant, self-controllable data file that enables self-management offering the creator protection and security. This capability can customize cognitive data per the creator's priorities. It also provides an intelligent means for unique configuration of the environment in order to protect the data while in use. Cognitive data are managed and controlled depending on the environment, state, security, health, and the intelligence level of the particular cognitive data instantiation. In this manner, the user is empowered to take control over and limit access to their data.

Thus, the present inventive subject matter relates to a cognitive data system for autonomous data decision processing, comprising the following elements operably coupled:

a) a data file stored on a storage medium or memory device, and having stored instructions for an embedded autonomous executable program which is executed each time there is an attempt to access, control, or manipulate said data file;

b) a processor for executing said program;

c) an output device for communicating to a user, wherein said communication is based on the result of executing said program in relation to parameters required for said data file by a data file original creator; and

d) an input device for receiving a communication from said user.

In one aspect of the inventive subject matter, said data file is selected from the group of consisting of text files, digital documents, digital databases, digital data files, electronic mail/email, digital media, digital content, analog media, temporal media, digital multimedia, and combinations thereof.

In another aspect of the inventive subject matter, said data file is selected from the group of consisting of non-real-time, near-real-time, and real-time data structures and/or protocols.

In a further aspect of the inventive subject matter said data file is selected from the group of consisting of encryption keys, decryption keys, digital signatures, certificates, message authentication codes, and other authentication codes.

In an alternate aspect of the inventive subject matter, said system further comprises a communication device for communicating via a communications network with a data file creator who originated or has legitimate ownership of the data.

In a preferred embodiment, said communication with said creator is (1) traceability information about said data file and/or said user, about said data file and/or said user's computational environment, or both, communicated to said creator, or (2) instructions to allow data access, instructions to deny data access, instructions to self-manipulate, or (3) to receive commands and/or resources communicated from said creator, or (4) combinations thereof.

In a more preferred embodiment, said self-manipulation comprise self-destruction, overwriting memory in which said data file resides, self-obfuscation, other self-modification, or combinations thereof.

In yet another aspect of the inventive subject matter, said embedded program causes said processor to autonomously execute one or more of the following additional steps:

a) evaluate, control, and/or configure its computational environment before disclosing data contents;

b) analyze a behavior of said user, of said environment, and/or of other executing processes, services, and programs;

c) perform intelligent data-to-data analysis, make conditional determinations, and present higher-order data conclusions;

d) perform intelligent environment situational analysis, make conditional determinations, and present higher-order data conclusions;

e) take necessary measures for self-protection;

f) perform self-management;

g) perform data search and/or discovery functions;

h) create a cognitive wrapper data file structure;

i) send an alert;

j) report user and/or environmental information back to the data creator;

k) receive and process commands from the creator;

l) determine user access, controls, and/or permissions to data;

m) log information;

n) execute policies which comprise rule-based logic;

o) execute network logic; or

p) combinations thereof.

In a preferred embodiment, said computational environment configuration comprises manipulating, restricting, and/or controlling user resources selected from the group consisting of: using currently executing processes, protocols, and/or services; opening other programs; closing other programs; opening communications ports; closing communications ports; activating devices; deactivating devices; activating or otherwise accessing resources; deactivating or otherwise accessing resources; initiating processes; terminating processes; and combinations thereof.

In another preferred embodiment, said necessary measures for self-protection comprise self-destruction, overwriting memory in which said data file resides, self-obfuscation, other self-modification, or combinations thereof.

In a further preferred embodiment, said data search and/or discovery functions utilize internal or external, short-term or long-term data memory comprising searchable memory tags.

In a more preferred embodiment, said memory tags comprise key words.

In another preferred embodiment, said network logic comprises network identifiers, protocol(s), network logic, or combinations thereof.

In another preferred embodiment, said receipt of commands from the creator enables the creator to remotely take control of said data file.

In another preferred embodiment, said creator remote control comprises capability for the creator to allow data file access, to deny data file access, to allow data file copying, to deny data file copying, to allow data file modification, to deny data file modification, to allow data file deletion, to deny data file deletion, to destroy the data file, to obfuscate the data file, or combinations thereof.

In a further preferred embodiment, said analysis of a user behavior comprises said user's activities and/or use patterns, wherein parameters associated to said user's behavior patterns comprise time-of-day access compared to said user's daily work schedule hours, said user's environment current internet protocol address or network identification and access data, environment past internet protocol addresses or network identification data and access data, typical frequency and duration of user accessing data, typical quantity of user data accessed, or combinations thereof.

In another preferred embodiment, said data-to-data analysis comprises a function that counts the number of data files that have been accessed by said user to determine if a pre-determined amount has been exceeded.

In another preferred embodiment, said data-to-data analysis comprises determination of data set similarities.

In a more preferred embodiment, said data-to-data similarities are determined based on the quantity of identifiers that are similar, concluding if data is tightly coupled or loosely coupled.

In a further preferred embodiment, said embedded program cause said processor to autonomously execute program instructions which execute a compromised-data alerting function.

In a more preferred embodiment, a compromised-data alert comprises the identity of an unauthorized party attempting to access, manipulate, and/or control said protected data file, the computational environment and/or location of said protected data file, the security status of said protected data file, or combinations thereof.

In a further preferred embodiment, said embedded program causes said processor to autonomously execute program instructions which execute a self-destruct function.

In another aspect of the inventive subject matter, said executable program has the capability to automate security policies.

In a preferred embodiment, said security policies are implemented based on cognitive analysis of data selected from the group comprising a user log, company working hours, data security sensitivity level, user identity, computational environment, user network resources, data security policy standards, security rules, and combinations thereof.

In another aspect of the inventive subject matter, said data file further comprises a cognitive encryption or decryption key file stored on a storage medium or memory device, and having stored instructions for an embedded autonomous executable program which is executed each time there is an attempt to access, control, or manipulate said encryption or decryption key file.

The inventive subject matter further relates to an apparatus for handling a cognitive data file with autonomous data decision processing, comprising a non-transitory computer readable medium having stored instructions for an embedded autonomous executable program which is executed each time there is an attempt to access, control, or manipulate said data file, wherein said program instructions when executed comprise the following steps:

a) querying a user of said apparatus and a user environment comprising said apparatus for information required by the original creator of said cognitive data file;

b) receiving and analyzing said information in relation to security parameters required by said original creator;

c) determining the computational environment of said user and analyzing said computational environment in relation to environmental parameters required by said original creator; and

d) permitting or denying said user's access to said data file based on said analysis of the user and computational environment.

In one aspect of the inventive subject matter, said data file is selected from the group of consisting of text, digital documents, digital databases, digital data files, electronic mail/email, digital media, digital content, analog media, temporal media, digital multimedia, and combinations thereof.

In another aspect of the inventive subject matter, said data file is selected from the group of consisting of non-real-time, near-real-time, and real-time data structures and/or protocols.

In another aspect of the inventive subject matter, said data file is selected from the group of consisting of encryption keys, decryption keys, digital signatures, certificates, message authentication codes, and other authentication codes.

In a further aspect of the inventive subject matter, said apparatus further comprises an interface for communicating via a communications network with a data file creator who originated or has legitimate ownership of the data.

In a preferred embodiment, said communication with said creator is (1) traceability information about said data file and/or said user, about said data file and/or said user's computational environment, or both, communicated to said creator, or (2) instructions to allow data access, instructions to deny data access, instructions to self-manipulate, or (3) to receive commands and/or resources communicated from said creator, or (4) combinations thereof.

In a more preferred embodiment, said self-manipulation comprise self-destruction, overwriting memory in which said data file resides, self-obfuscation, other self-modification, or combinations thereof.

In an alternate aspect of the inventive subject matter, said embedded program autonomously executes one or more of the following additional steps:

a) evaluate, control, and/or configure its computational environment before disclosing data contents;

b) analyze a behavior of said user, of said environment, and/or of other executing processes, services, and programs;

c) perform intelligent data-to-data analysis, make conditional determinations, and present higher-order data conclusions;

d) perform intelligent environment situational analysis, make conditional determinations, and present higher-order data conclusions;

e) take necessary measures for self-protection;

f) perform self-management;

g) perform data search and/or discovery functions;

h) create a cognitive wrapper data file structure;

i) send an alert;

j) report user and/or environmental information back to the data creator;

k) receive and process commands from the creator;

l) determine user access, controls, and/or permissions to data;

m) log information;

n) execute policies which comprise rule-based logic;

o) execute network logic; or

p) combinations thereof.

In a preferred embodiment, said computational environment configuration comprises manipulating, restricting, and/or controlling user resources selected from the group consisting of: using currently executing processes, protocols, and/or services; opening other programs; closing other programs; opening communications ports; closing communications ports; activating devices; deactivating devices; activating or otherwise accessing resources; deactivating or otherwise accessing resources; initiating processes; terminating processes; and combinations thereof.

In another preferred embodiment, said necessary measures for self-modification comprise self-destruction, overwriting memory in which said data file resides, self-obfuscation, other self-modification, or combinations thereof.

In a further preferred embodiment, said data search and/or discovery functions utilize internal or external, short-term or long-term data memory comprising searchable memory tags.

In a more preferred embodiment, said memory tags comprise key words.

In another preferred embodiment, said network logic comprises network identifiers, protocol(s), network logic, or combinations thereof.

In another preferred embodiment, said receipt of commands from the creator enables the creator to remotely take control of said data file.

In another preferred embodiment, said creator remote control comprises capability for the creator to allow data file access, to deny data file access, to allow data file copying, to deny data file copying, to allow data file modification, to deny data file modification, to allow data file deletion, to deny data file deletion, to destroy the data file, or combinations thereof.

In a further preferred embodiment, said analysis of a user behavior comprises said user's activities and/or use patterns wherein parameters associated to said user's behavior patterns comprise time-of-day access compared to said user's daily work schedule hours, said user's environment current internet protocol address or network identification and access data, environment past internet protocol addresses or network identification data and access data, typical frequency and duration of user accessing data, typical quantity of user data accessed, or combinations thereof.

In yet another preferred embodiment, said data-to-data analysis comprises a function that counts the number of data files that have been accessed by said user to determine if a pre-determined amount has been exceeded.

In a further preferred embodiment, said data-to-data analysis comprises determination of data set similarities.

In a more preferred embodiment, said data-to-data similarities are determined based on the quantity of identifiers that are similar, concluding if data is tightly coupled or loosely coupled.

In another preferred embodiment, said embedded program causes said processor to autonomously executes program instructions which execute a compromised-data alerting function.

In a more preferred embodiment, a compromised-data alert comprises the identity of an unauthorized party attempting to access, manipulate, and/or control said protected data file, the computational environment and/or location of said protected data file, the security status of said protected data file, or combinations thereof.

In a further preferred embodiment, said embedded program causes said processor to autonomously execute(s) program instructions which execute a self-destruct function.

In yet another aspect of the inventive subject matter, said executable program has the capability to automate security policies.

In a preferred embodiment, said security policies are implemented based on cognitive analysis of data selected from the group comprising a user log, company working hours, data security sensitivity level, user identity, computational environment, user network resources, data security policy standards, security rules, and combinations thereof.

In another aspect of the inventive subject matter, said data file further comprising a cognitive encryption or decryption key file stored on a storage medium or memory device, and having stored instructions for an embedded autonomous executable program which is executed each time there is an attempt to access, control, or manipulate said encryption or decryption key file.

In another aspect of the inventive subject matter, said non-transitory computer readable medium comprises a storage medium or memory device.

The inventive subject matter also relates to a method for securing a cognitive data file stored in a storage medium or memory device, said data file having stored instructions for an embedded autonomous executable program which is executed each time there is an attempt to access, control, or manipulate said data file, comprising the following steps:

a) querying a user of said data file and the user environment of said data file for information required by the original creator of said cognitive data file;

b) receiving and analyzing said information in relation to security parameters required by said original creator;

c) determining the computational environment of said user and analyzing said computational environment in relation to environmental parameters required by said original creator; and

d) permitting or denying said user's access to said data file based on said analysis of the user and computational environment.

In one aspect of the inventive subject matter, said data file is selected from the group of consisting of text files, digital documents, digital databases, digital data files, electronic mail/email, digital media, digital content, analog media, temporal media, digital multimedia, and combinations thereof.

In another aspect of the inventive subject matter, said data file is selected from the group of consisting of non-real-time, near-real-time, and real-time data structures and/or protocols.

In a further aspect of the inventive subject matter said data file is selected from the group of consisting of encryption keys, decryption keys, digital signatures, certificates, message authentication codes, and other authentication codes.

In an alternate aspect of the inventive subject matter, said system further comprises a communication device for communicating via a communications network with a data file creator who originated or has legitimate ownership of the data.

In a preferred embodiment, said communication with said creator is (1) traceability information about said data file and/or said user, about said data file and/or said user's computational environment, or both, communicated to said creator, or (2) instructions to allow data access, instructions to deny data access, instructions to self-manipulate, or (3) to receive commands and/or resources communicated from said creator, or (4) combinations thereof.

In a more preferred embodiment, said self-manipulation comprise self-destruction, overwriting memory in which said data file resides, self-obfuscation, other self-modification, or combinations thereof.

In yet another aspect of the inventive subject matter, said embedded program causes said processor to autonomously execute one or more of the following additional steps:

a) evaluate, control, and/or configure its computational environment before disclosing data contents;

b) analyze a behavior of said user, of said environment, and/or of other executing processes, services, and programs;

c) perform intelligent data-to-data analysis, make conditional determinations, and present higher-order data conclusions;

d) perform intelligent environment situational analysis, make conditional determinations, and present higher-order data conclusions;

e) take necessary measures for self-protection;

f) perform self-management;

g) perform data search and/or discovery functions;

h) create a cognitive wrapper data file structure;

i) send an alert;

j) report user and/or environmental information back to the data creator;

k) receive and process commands from the creator;

l) determine user access, controls, and/or permissions to data;

m) log information;

n) execute policies which comprise rule-based logic;

o) execute network logic; or

p) combinations thereof.

In a preferred embodiment, said computational environment configuration comprises manipulating, restricting, and/or controlling user resources selected from the group consisting of: using currently executing processes, protocols, and/or services; opening other programs; closing other programs; opening communications ports; closing communications ports; activating devices; deactivating devices; activating or otherwise accessing resources; deactivating or otherwise accessing resources; initiating processes; terminating processes; and combinations thereof.

In another preferred embodiment, said necessary measures for self-protection comprise self-destruction, overwriting memory in which said data file resides, self-obfuscation, other self-modification, or combinations thereof.

In a further preferred embodiment, said data search and/or discovery functions utilize internal or external, short-term or long-term data memory comprising searchable memory tags.

In a more preferred embodiment, said memory tags comprise key words.

In another preferred embodiment, said network logic comprises network identifiers, protocol(s), network logic, or combinations thereof.

In another preferred embodiment, said receipt of commands from the creator enables the creator to remotely take control of said data file.

In another preferred embodiment, said creator remote control comprises capability for the creator to allow data file access, to deny data file access, to allow data file copying, to deny data file copying, to allow data file modification, to deny data file modification, to allow data file deletion, to deny data file deletion, to destroy the data file, to obfuscate the data file, or combinations thereof.

In a further preferred embodiment, said analysis of a user behavior comprises said user's activities and/or use patterns, wherein parameters associated to said user's behavior patterns comprise time-of-day access compared to said user's daily work schedule hours, said user's environment current internet protocol address or network identification and access data, environment past internet protocol addresses or network identification data and access data, typical frequency and duration of user accessing data, typical quantity of user data accessed, or combinations thereof.

In another preferred embodiment, said data-to-data analysis comprises a function that counts the number of data files that have been accessed by said user to determine if a pre-determined amount has been exceeded.

In another preferred embodiment, said data-to-data analysis comprises determination of data set similarities.

In a more preferred embodiment, said data-to-data similarities are determined based on the quantity of identifiers that are similar, concluding if data is tightly coupled or loosely coupled.

In a further preferred embodiment, said embedded program cause said processor to autonomously execute program instructions which execute a compromised-data alerting function.

In a more preferred embodiment, a compromised-data alert comprises the identity of an unauthorized party attempting to access, manipulate, and/or control said protected data file, the computational environment and/or location of said protected data file, the security status of said protected data file, or combinations thereof.

In a further preferred embodiment, said embedded program causes said processor to autonomously execute program instructions which execute a self-destruct function.

In another aspect of the inventive subject matter, said executable program has the capability to automate security policies.

In a preferred embodiment, said security policies are implemented based on cognitive analysis of data selected from the group comprising a user log, company working hours, data security sensitivity level, user identity, computational environment, user network resources, data security policy standards, security rules, and combinations thereof.

In another aspect of the inventive subject matter, said data file further comprises a cognitive encryption or decryption key file stored on a storage medium or memory device, and having stored instructions for an embedded autonomous executable program which is executed each time there is an attempt to access, control, or manipulate said encryption or decryption key file.

While only certain preferred features of the invention have been shown by way of illustration of particular aspects of the inventive subject matter, many modifications and changes will occur to those skilled in the art. For example, another embodiment may only process select or stripped data as cognitive data while all other data may not be considered as necessary to become intelligent. This invention is intended to provide the foundation enabler for data cognition. Other advanced processes can be performed leveraging the disclosed cognition capability which may comprise additional IAs to increase cognition features and leverage more robust data discovery capabilities as well as support the Quality of Information Assurance (QoIA). It is, therefore, to be understood that the present claims are intended to cover all such modifications and changes which fall within the true spirit of the invention.

### ADDITIONAL REFERENCES

The following literature references are believed to useful to an understanding of the inventive subject matter in the context of its place in the relevant art. Citation here is not to be construed as an assertion or admission that any reference cited is material to patentability of the inventive subject matter. Applicants will properly disclose information material to patentability in an Information Disclosure Statement. Each of the following documents is hereby incorporated by reference in its entirety in this application.
Press Release from Internet dated Feb. 21, 2008, “Attack on Computer Memory Reveals Vulnerability of Widely Used Security Systems”
Press Release from Internet dated, Sep. 24, 2007, “Employee error fuels data security breaches”
Press Release from Internet dated, Sep. 8, 2007, “China's cyber army is preparing to march on America, says Pentagon”
Brochure from Internet not dated, Security and Intelligent Documents Business Unit, “Security Today, Security and Intelligent Documents for Federal Agencies”, by US Government Printing Office

The inventive subject matter being thus described, it will be obvious that the same may be modified or varied in many ways. Such modifications and variations are not to be regarded as a departure from the spirit and scope of the inventive subject matter and all such modifications and variations are intended to be included within the scope of the following claims.

We claim:

1) An apparatus for handling a cognitive data file with autonomous data decision processing, comprising a non-transitory computer readable medium having stored instructions for an embedded autonomous executable program which is executed each time there is an attempt to access, control, or manipulate said data file, wherein said program instructions when executed comprise the following steps:
a) querying a user of said apparatus and a user environment comprising said apparatus for information required by the original creator of said cognitive data file;
b) receiving and analyzing said information in relation to security parameters required by said original creator;
c) determining the computational environment of said user and analyzing said computational environment in relation to environmental parameters required by said original creator; and
d) permitting or denying said user's access to said data file based on said analysis of the user and computational environment.

2) The apparatus of claim 1, wherein said data file is selected from the group of consisting of text, digital documents, digital databases, digital data files, electronic mail/email, digital media, digital content, analog media, temporal media, digital multimedia, and combinations thereof.

3) The apparatus of claim 1, wherein said data file is selected from the group of consisting of non-real-time, near-real-time, and real-time data structures and/or protocols.

4) The apparatus of claim 1, wherein said data file is selected from the group of consisting of encryption keys, decryption keys, digital signatures, certificates, message authentication codes, and other authentication codes.

5) The apparatus of claim 1, further comprising an interface for communicating via a communications network with a data file creator who originated or has legitimate ownership of the data.

6) The apparatus of claim 5, wherein said communication with said creator is (1) traceability information about said data file and/or said user, about said data file and/or said user's computational environment, or both, communicated to said creator, or (2) instructions to allow data access, instructions to deny data access, instructions to self-manipulate, or (3) to receive commands and/or resources communicated from said creator, or (4) combinations thereof.

7) The apparatus of claim 6, wherein said self-manipulation comprise self-destruction, overwriting memory in which said data file resides, self-obfuscation, other self-modification, or combinations thereof.

8) The apparatus of claim 1, wherein said embedded program autonomously executes one or more of the following additional steps:
a) evaluate, control, and/or configure its computational environment before disclosing data contents;
b) analyze a behavior of said user, of said environment, and/or of other executing processes, services, and programs;
c) perform intelligent data-to-data analysis, make conditional determinations, and present higher-order data conclusions;
d) perform intelligent environment situational analysis, make conditional determinations, and present higher-order data conclusions;
e) take necessary measures for self-protection;
f) perform self-management;
g) perform data search and/or discovery functions;
h) create a cognitive wrapper data file structure;
i) send an alert;
j) report user and/or environmental information back to the data creator;
k) receive and process commands from the creator;
l) determine user access, controls, and/or permissions to data;
m) log information;
n) execute policies which comprise rule-based logic;
o) execute network logic; or
p) combinations thereof.

9) The apparatus of claim 8, wherein said computational environment configuration comprises manipulating, restricting, and/or controlling user resources selected from the group consisting of: using currently executing processes, protocols, and/or services; opening other programs; closing other programs; opening communications ports; closing communications ports; activating devices; deactivating devices; activating or otherwise accessing resources; deactivating or otherwise accessing resources; initiating processes; terminating processes; and combinations thereof.

10) The apparatus of claim 8, wherein said necessary measures for self-modification comprise self-destruction, overwriting memory in which said data file resides, self-obfuscation, other self-modification, or combinations thereof.

11) The apparatus of claim 8, wherein said data search and/or discovery functions utilize internal or external, short-term or long-term data memory comprising searchable memory tags.

12) The apparatus of claim 11, wherein said memory tags comprise key words.

13) The apparatus of claim 8, wherein said network logic comprises network identifiers, protocol(s), network logic, or combinations thereof.

14) The apparatus of claim 8, wherein said receipt of commands from the creator enables the creator to remotely take control of said data file.

15) The apparatus of claim 8, wherein said creator remote control comprises capability for the creator to allow data file access, to deny data file access, to allow data file copying, to deny data file copying, to allow data file modification, to deny data file modification, to allow data file deletion, to deny data file deletion, to destroy the data file, or combinations thereof.

16) The apparatus of claim 8, wherein said analysis of a user behavior comprises said user's activities and/or use patterns wherein parameters associated to said user's behavior patterns comprise time-of-day access compared to said user's daily work schedule hours, said user's environment current internet protocol address or network identification and access data, environment past internet protocol addresses or network identification data and access data, typical frequency and duration of user accessing data, typical quantity of user data accessed, or combinations thereof.

17) The apparatus of claim 8, wherein said data-to-data analysis comprises a function that counts the number of data files that have been accessed by said user to determine if a pre-determined amount has been exceeded.

18) The apparatus of claim 8, wherein said data-to-data analysis comprises determination of data set similarities.

19) The apparatus of claim 18, wherein said data-to-data similarities are determined based on the quantity of identifiers that are similar, concluding if data is tightly coupled or loosely coupled.

20) The apparatus of claim 8, wherein said embedded program causes said processor to autonomously executes program instructions which execute a compromised-data alerting function.

21) The apparatus of claim 20, wherein a compromised-data alert comprises the identity of an unauthorized party attempting to access, manipulate, and/or control said protected data file, the computational environment and/or location of said protected data file, the security status of said protected data file, or combinations thereof.

22) The apparatus of claim 8, wherein said embedded program causes said processor to autonomously execute(s) program instructions which execute a self-destruct function.

23) The apparatus of claim 1, wherein said executable program has the capability to automate security policies.

24) The apparatus of claim 23, wherein said security policies are implemented based on cognitive analysis of data selected from the group comprising a user log, company working hours, data security sensitivity level, user identity, computational environment, user network resources, data security policy standards, security rules, and combinations thereof.

25) The apparatus of claim 1, said data file further comprising a cognitive encryption or decryption key file stored on a storage medium or memory device, and having stored instructions for an embedded autonomous executable program which is executed each time there is an attempt to access, control, or manipulate said encryption or decryption key file.

26) The apparatus of claim 1, wherein said non-transitory computer readable medium comprises a storage medium or memory device.
